(19) United States
(12) Patent Application Publication
(10) Pub. No.: US 2012/0058230 A1
(43) Pub. Date: Mar. 8, 2012

(54) METHOD AND A SYSTEM FOR PRESSURISING AND DISPENSING CARBONATED BEVERAGES

(76) Inventors: Jan Norager Rasmussen, Olstykke (DK); Steen Vesborg, Gentofte (DK)

(21) Appl. No.: 13/264,149

(22) PCT Filed: Apr. 14, 2010
(86) PCT No.: PCT/EP2010/054874

§ 371 Date: Nov. 10, 2011

(30) Foreign Application Priority Data
Apr. 15, 2009 (EP) 09388011.0
Apr. 23, 2009 (EP) 09388012.8

(51) Int. Cl. B67D 1/04; B65D 83/14

(52) U.S. Cl. 426/115; 261/74; 426/394

(57) ABSTRACT

A self regulating and constant pressure maintaining beverage dispenser assembly comprises a dispensing device and a beverage container defining an inner space constituting a beverage space filled with carbonated beverage and communicating with the dispensing device for allowing dispensation of the carbonated beverage, and a head space communicating with the beverage space and filled with CO₂ having an initial pressure of 0.1-3 bar above the atmospheric pressure when subjected to a specific temperature of 2° C.-50° C. preferably 3° C.-25° C. and more preferably 5° C.-15° C. The beverage dispenser assembly further comprises at least one carbonisation canister communicating with the head space via a hydrophobic labyrinth and comprising a particular amount of adsorption material having adsorbed a specific amount of CO₂. The particular amount of adsorption material is inherently capable of regulating the pressure in the head space and of preserving the carbonisation of the carbonated beverage in the beverage space by releasing CO₂ into the head space.

### CROSS-REFERENCE TO RELATED APPLICATION

This application is a national phase filing, under 35 U.S.C. §371(c), of International Application No. PCT/EP2010/054874, filed Apr. 14, 2010, the disclosure of which is incorporated herein by reference in its entirety.

### FEDERALLY SPONSORED RESEARCH OR DEVELOPMENT

Not Applicable

### BACKGROUND

The present invention relates to a method and a system for pressurising and dispensing carbonated beverages stored in a keg or container.

Carbonated beverages, such as beer and soft drinks, are typically provided under elevated pressure in pressure-proof containers such as cans or kegs. Once the keg or can has been opened, the pressure reduction in the container will cause the carbon dioxide dissolved in the beverage to escape. After some time, such as a few hours, the escape of carbon dioxide (CO₂) will cause the beverage to become unsuitable for drinking for the beverage consumer, since it will assume a flat and less flavoured taste. For non-professional users, such as households and similar private users, carbonated beverages are typically provided in small containers such as bottles or cans which are suitable for a single serving of beverage and have a volume around 0.25-1.5 litres. The consumer is expected to finish the can or bottle within a few hours and preferably less, since when the beverage container has been opened CO₂ will start escaping the beverage. Additionally, oxygen will enter the beverage. The oxygen entering the beverage container causes the beverage to deteriorate and will decrease the storage time of the beverage inside the opened beverage container. Typically, the quality of the beverage and the intensity of carbonisation will have reached unacceptably low levels within a few hours or at most a few days depending on external conditions after opening the beverage container and the possibility of re-sealing the beverage container.

Professional users such as bars and restaurants and similar establishments having a large turnover of carbonated beverages may use a beverage dispensing system intended for multiple servings of beverage instead of individual bottles and cans. Professional beverage dispensing systems typically use large beverage containers, such as kegs, which are connected to a carbon dioxide source for carbonating the beverage and for maintaining a pressure inside the beverage container while dispensing the beverage through a tapping device. Thus, the level of carbon dioxide in the beverage may be held constant while at the same time oxygen is prevented from entering the container. Thus, a beverage inside a beverage container connected to a beverage dispensing system may be kept in suitable drinking condition for weeks since the beverage dispensing system is effectively compensating for the loss of carbon dioxide from the beverage, substituting the dispensed beverage volume for maintaining an elevated pressure inside the beverage container as well as keeping the drink free from oxygen, which would otherwise deteriorate the flavour of the beverage. Beverage dispensing systems may also include a cooling device for keeping the beverage at suitable drinking and storage temperature and are typically reusable, i.e. when a beverage keg is empty, the beverage dispensing system may be opened and a new full beverage keg may be installed.

Professional beverage dispensing systems typically operate with large containers or kegs, which may contain 10-50 litres or more of beverage. Smaller and portable beverage dispensing systems for private or professional use may typically contain 5-10 litres of beverage. One example of a beverage dispensing system is the DraughtMaster™ system provided by the applicant company and described in the PCT applications WO2007/019848, WO2007/019849, WO2007/019850, WO2007/019851 and WO2007/019853. The DraughtMaster™ system seals the beverage container from the surrounding oxygen and provides pressurisation and cooling to avoid loss of carbon dioxide and deterioration of the beverage.

Some consumers prefer to use a so-called mini-keg or party-keg when providing beverage at minor social events, such as private parties, family events and conferences etc. Mini-kegs may also be used in professional beverage dispensing establishments, such as for smaller professional establishments, establishments lacking access to pressurisation sources and establishments where highly pressurised containers may be unsuitable, such as in airplanes and other means of transportation A mini-keg is a cheap and single-use beverage dispenser assembly for providing a larger amount of beverage than allowed in a can while not requiring the consumer to invest in a reusable beverage dispensing system. The mini-keg allows multiple beverage servings without loss of carbonisation or flavour even if some time is allowed to pass between the servings. It also gives the user the option of choosing the amount of beverage for each serving. Typically, state of the art mini-kegs constitute single use beverage dispensing systems and include a tapping device for dispensing the beverage and a carbon dioxide cartridge for keeping the beverage in the mini-keg in a suitable drinking condition over an extended time period such as several days or weeks, even if the mini-keg has been opened. For avoiding loss of carbonisation and flavour, mini-kegs include a carbonisation cartridge for keeping a pressurised carbon dioxide atmosphere inside the keg and compensate for pressure loss due to beverage dispensing. Such mini-kegs typically having a volume ranging between the professional kegs and the single-use cans, such as 2-15 litres or 3-10 litres and in particular 5 litres. Furthermore, mini-kegs are known in which no carbon dioxide regulation is included.

There is thus a need for a cheap and simple solution for pressurising a beverage keg. Some examples of self-pressurising beverage kegs are found in European patent publications EP 1 737 759 and EP 1 170 247. Both the above known technologies make use of commercially available CO₂ cartridges containing pressurised CO₂ (carbon dioxide) and a pressure regulation mechanism. The CO₂ cartridges release CO₂ via the pressure regulator, which is used for pressurising the beverage and the beverage container as the pressure is reduced due to the dispensing of the beverage as well as due to leakage during storage of the beverage keg in-between servings. The cartridge will occupy space, which cannot be used for beverage. Therefore, the cartridge should preferably be small in relation to the volume of the beverage container. To be able to generate a suitable amount of CO₂ from a small cartridge to pressurise a significantly larger beverage container the cartridge must have a high pressure. The above-mentioned publications EP 1 737 759 and EP 1 170 247 suggest the use of a filler material such as activated carbon for reducing the pressure inside the cartridge.

The above-mentioned technologies have some drawbacks. The high pressure in the cartridges of the above-mentioned technologies may constitute a safety hazard due to the risk of explosion, especially in case the cartridge is heated. The above technologies further include a mechanical pressure-reducing regulator, which may jam or break. It is therefore an object of the present invention to provide technologies for dispensing and pressurising a beverage stored inside a container without the use of high-pressurised cartridges and where the pressure in the cartridge remains only slightly above ambient pressure, at least during normal beverage dispensing operations.

The CO₂ cartridge and the pressure regulator must typically be made of metal to withstand the high pressures. Some mini-kegs may therefore be made entirely out of metal or a combination of metal and plastic. While many plastic materials may be disposed of in an environmentally friendly manner by combustion, metal should be recycled in order to be considered an environment friendly material. However, in many cases the above metal mini-kegs are not suitable for recycling since they differ from normal recyclable metal cans and kegs since they may contain a multitude of different plastic materials, which may not be separable and recyclable or disposed of in an environment friendly manner. There is thus a risk that such mini-kegs will not be properly recycled. There is thus a need for disposable mini-kegs of a single disposable material, which may be disposed of in an environment-friendly manner. It is therefore a further object of the present invention to provide a disposable beverage dispenser assembly.

### SUMMARY

The above need and the above object together with numerous other needs and objects which will be evident from the below detailed description are according to a first aspect of the present invention obtained by a self regulating and constant pressure maintaining beverage dispenser assembly comprising a dispensing device and a beverage container, the beverage container defining an inner space, the inner space constituting:
a beverage space filled with carbonated beverage and communicating with the dispensing device for allowing dispensing of the carbonated beverage, and
a head space communicating with the beverage space and filled with CO₂ having an initial pressure of 0.1-3 bar above the atmospheric pressure when subjected to a specific temperature of 2° C.-50° C., preferably 3° C.-25° C. and more preferably 5° C.-15° C.,
the beverage dispenser assembly further comprising at least one carbonisation canister communicating with the head space via a hydrophobic labyrinth and comprising a particular amount of adsorption material having adsorbed a specific amount of CO₂, the particular amount of adsorption material being inherently capable of regulating the pressure in the head space and capable of preserving the carbonisation of the carbonated beverage in the beverage space by releasing CO₂ into the head space via the hydrophobic labyrinth or by adsorbing CO₂ from the head space via the hydrophobic labyrinth, the specific amount of CO₂ being sufficient for allowing the head space to increase in volume and substituting the beverage space when the carbonated beverage having the specific temperature is being dispensed from the container by using the dispensing device and maintaining the initial pressure, or at least a pressure of 0.1-3 bar above the atmospheric pressure in the head space during the complete substitution of the beverage space by the head space.

By self-regulating is in the present context understood that the pressure regulation is inherent in the beverage dispensing assembly and that no external supply of gas is required. The pressure should be maintained in the beverage dispensing preferably without any substantial loss of pressure in the beverage space for avoiding the carbonated beverage from becoming flat. Since maintaining a constant pressure may require large volumes of adsorption material, it may in some cases be preferred to allow a certain pressure loss in the beverage space provided that a sufficient driving pressure remains for allowing an efficient beverage dispensing.

By self-regulating, the inherent pressure regulation is further established in accordance with and while maintaining the equilibrium of the beverage, i.e. without causing to any substantial extent any change in the beverage as such, also including the carbon dioxide content of the beverage, and in doing so preventing any change of the beverage, which change might else deteriorate the taste of the beverage. It is to be understood that the most critical issue in relation to pressure regulation in the beverage dispensing assembly is the preservation of the taste of the beverage or alternatively the elimination of any substantial change of the taste due to change of the content of carbon dioxide or any other constituent of the beverage.

The beverage container may preferably be blow moulded for allowing a large inner space in relation to the raw material usage. The inner space may in some cases be compartmentalised, such as a flexible inner bag defining the beverage space and a rigid outer container defining the head space between the inner bag and the outer container, also known from e.g. bag-in-keg and bag-in-box concepts, however, in most cases the inner space will be unitary. The beverage space is defined by the portion of the inner space which is filled with carbonated beverage. The dispensing device typically comprises a tapping line and a tapping valve. The tapping line may constitute an ascending pipe and/or a tapping hose. The tapping valve should normally be in a closed position preventing beverage dispensing except when beverage dispensing is desired where the valve should be temporarily shifted to an open position allowing a user-defined amount of beverage to flow from the beverage space via the dispensing device into a glass or the like supplied by the user and positioned close to the outlet of the tapping valve.

The head space is defined by the portion of the inner space which is not filled with beverage. The head space is typically located above the beverage space and is delimited from the beverage space by the surface of the carbonated beverage. The initial pressure in the head space should be elevated in relation to the outside atmospheric pressure for preserving the carbonisation of the carbonated beverage and preserving the equilibration of the carbonated beverage. It is contemplated that the pressure in the inner space is uniform, i.e. the pressure is equal in the head space and the beverage space. The initial pressure in the head space may range from 0.1-3 bar depending on the kind of carbonated beverage and the dispensing pressure needed for causing the beverage to flow out through the dispensing device. The initial pressure also influences the initial carbonisation of the beverage, i.e. a high initial CO₂ pressure causes the beverage to absorb more CO₂, which results in a high level of carbonisation of the beverage. It is contemplated that different kinds of carbonated beverages may have a different desired carbonisation level. Especially concerning beer, the initial carbonisation varies greatly between different kinds of beer.

The beverage temperature at the time of serving is typically slightly lower than room temperature in the range of 5° C.-15° C. for most carbonated beverages. To reach such temperatures, the beverage container may be stored in a cool storage room or refrigerator. The carbonated beverage contains water and CO₂, which is dissolved in the water. When the beverage temperature sinks, more CO₂ is allowed to dissolve in the water, and vice versa when the beverage temperature is elevated, the water may contain less CO₂ and consequently CO₂ is dissolved and causing a pressure increase in the beverage container. It is contemplated that the beverage container may be stored at temperatures differing from the typical serving temperatures. Such storing temperatures may typically range from about 2° C.-50° C.

The canisters provided for communicating with the head space may preferably be located inside the inner space of the beverage container, however, in some embodiments it may be preferred to locate the canisters outside the beverage container and connect the head space and the canister by a hose. The canister may e.g. be floating at the surface between the beverage space and the head space. The hydrophobic labyrinth is intended for preventing any beverage from accidentally entering the canister and for keeping the interior of the canister dry. The canister is filled with the adsorption material capable of adsorbing and releasing a large amount of CO₂ per volume unit when stored in a dry state. The adsorption material inside the canister should be primarily communicating with the head space, at least when the beverage container is in a stable position. However, since the head space is communicating with the beverage space, beverage may occasionally enter the head space, especially when the beverage container is moved. Beverage entering the canister and coming into contact with the adsorption material may significantly reduce the efficiency of the adsorption material. The hydrophobic labyrinth may e.g. be a membrane of a porous material or the like capable of preventing liquid communication and allowing gaseous communication between the adsorption material and the head space. Any number of canisters may be used, e.g. one large canister or alternatively a plurality of small canisters.

When the tapping valve is opened the pressure in the head space drives the beverage out of the beverage container, thereby reducing the beverage space and substituting it by the head space. As the volume in the head space is increased during beverage dispensing, the pressure is reduced, provided the beverage temperature is constant. The pressure in the head space is also slowly reduced during storage due to diffusion through the beverage container materials. Without the provision of the canister or canisters having adsorption material, the reduced pressure in the head space would cause less pressure for dispensing the beverage and finally an interruption of the beverage dispensing operation when the pressure has equalised between the inner space and the outside. A lower pressure inside the beverage space would also cause the CO₂ in the beverage to escape, causing the beverage to go flat and become unsuitable for serving. By providing canisters having the particular amount of adsorption material which is sufficient for allowing the adsorption material to adsorb a specific amount of CO₂ sufficient for substituting the complete beverage space without any significant pressure loss in the head space, the driving pressure as well as the carbonisation of the beverage is maintained. The driving pressure is understood to be the pressure difference between the inner space and the outside needed for dispensing the beverage. By choosing an adsorption material having a high adsorption capability, the canisters as well as the head space may be small in relation to the beverage space which will reduce the use of material. The adsorption material should have an inherent capability of both adsorbing and releasing CO₂ depending on the pressure in the head space. A reduction of the pressure in the head space will be immediately counteracted by the adsorption material inherently releasing CO₂ for substantially neutralising the pressure reduction, thereby preventing the carbonated beverage from going flat and maintaining the beverage driving pressure. In the present context, it is understood that a certain pressure loss is unavoidable during the complete dispensation of the beverage in the beverage container, however, by providing a sufficiently large particular amount of adsorption material and specific amount of CO₂, the pressure loss may be minimised for at least substantially maintaining the pressure. Additionally, for some beverages a larger pressure loss may be tolerated, as long as the driving pressure is sufficient. It should especially be noted that in contrast to the prior art, the present canisters will not require any mechanical pressure regulators of any kind, since the regulation is inherent in the adsorption material.

Although it is recommended to enjoy most beverages at a certain beverage-specific temperature, some consumers may like their beverage at a slightly different temperature than other consumers. In some cases proper cooling of the beverage container may not be available due to e.g. lack of refrigeration or cold storage. Since the beverage dispensing assembly typically will be portable, it is further contemplated that some users will transport it to locations having no cooling possibilities, such as public or private gardens, recreation areas, sports arenas, beaches etc. In case of temperature rise, the CO₂ of the carbonated beverage will release into the head space, causing a pressure rise in the head space. Such a temperature dependent pressure rise is well known among consumers of carbonated beverages and may lead to an undesired dispensing behaviour and spillage. In such cases, the adsorption material in the canister will counteract to neutralise the pressure rise by adsorbing the CO₂ released by the carbonated beverage. The canister will allow suitable beverage dispensing behaviour over a much broader temperature range than allowed by standard state of the art products by allowing re-adsorption of excessive CO₂.

According to a further embodiment of the first aspect, the head space and the canister have an initial pressure of less than 2 bar above the atmospheric pressure, preferably less than 1.5 bar above the atmospheric pressure and more preferably less than 1 bar above the atmospheric pressure. A smaller initial pressure is typically preferred for avoiding over-carbonisation of the beverage and allowing a suitable dispensing behaviour. By using a particular amount of adsorption material which is sufficient for allowing the adsorption material to adsorb a specific amount of CO₂ sufficient for substituting the complete beverage space, the initial pressure in head space and canister can be maintained low without the need for having a very high pressure in the head space and/or canister for allowing a complete substitution of the beverage space.

According to a further embodiment of the first aspect, the head space, after the complete substitution of the beverage space by the head space, has a pressure of at least 0.5 bar above the atmospheric pressure, preferably at least 0.75 bar above the atmospheric pressure and more preferably at least 1 bar above the atmospheric pressure. Typically, a pressure of at least 0.5 bar above the atmospheric pressure is needed for maintaining a suitable carbonisation of the beverage and a driving pressure. For allowing the complete dispensation of the carbonated beverage, the pressure should be maintained until the beverage container is empty, or at least for an extended time period comparable to the maximum storage time of the beverage, such as at least 1-2 weeks, preferably 1-2 months or more preferably 1-2 years.

According to a further embodiment of the first aspect, the beverage space initially occupies at least 70% of the inner space, preferably 75%, more preferably 80% and most preferably 85%. The head space is a part of the inner space of the beverage container which does not contribute to storing beverage and may thus be considered a waste since the beverage container must be manufactured and transported having a larger inner space than needed for the beverage space. By having canisters with an efficient adsorbing material capable of storing the specific amount of CO₂ needed to substitute the beverage space, the head space may be smaller. For economical reasons, the head space should not occupy more than 30% of the inner space of the beverage container, leaving 70% of the inner space for the beverage space. Preferably, the beverage space occupies an even larger portion of the inner space.

According to a further embodiment of the first aspect, the beverage space has a volume of 0.5-50 litres, preferably 2-10 litres, more preferably 3-7 litres and most preferably 5 litres, such as 3-5 litres or 5-7 litres. The present beverage dispensing assembly typically comes with a beverage space holding about 5 litres of beverage, since it is an appropriate volume being suitable for multiple servings while being portable by a single person. Beverage spaces being smaller than 0.5 litres are intended for single servings only, and the initial pressurisation may be sufficient for completing the beverage. Very large beverage containers of e.g. 100 litres are less portable and typically intended for professional use in a professional beverage dispensing system being chilled and externally pressurised. Beverage spaces of the above volumes around 2-10 litres are presently rare in the market due to the above-mentioned problems of keeping the pressure in the inner space, but it is expected that beverage dispensing assemblies having such volumes of the beverage spaces will achieve a significant market share.

According to a further embodiment of the first aspect, the carbonisation canister allows the adsorption material to adsorb CO₂ when the beverage container is being heated above the specific temperature for avoiding any substantial increase of the pressure in the head space. In some cases the beverage container may be heated above the specific temperature which is suitable for serving. Such heating may occur accidentally, e.g. due to fire, incoming solar radiation or warm climate, but also intentionally, e.g. during pasteurisation. In such cases the pressure will rise in the inner space. Such pressure rise may in extreme cases lead to a rupture or explosion of the beverage container. The pressure rise in the inner space will however be counteracted by an increased adsorption by the adsorption material in the canisters, thus any substantial pressure increase may be avoided even when the beverage container is subjected to high temperatures. The present beverage container may thus be regarded as being explosion proof, which is an important safety feature.

According to a further embodiment of the first aspect, the carbonisation canister allows the adsorption material to release CO₂ when the beverage container is being chilled below the specific temperature for avoiding any substantial decrease of the pressure in the head space. In other cases, the beverage container is being chilled, e.g. by being placed in a cooling space or refrigerator. As discussed above, the beverage absorbs CO₂ when being chilled, thereby lowering the pressure in the head space which may lead to dispensing difficulties, since the driving pressure is reduced. In such cases the adsorption material in the canister releases CO₂ for maintaining a sufficient carbonisation and driving pressure.

According to a further embodiment of the first aspect, the hydrophobic labyrinth comprises a gas permeable, liquid impermeable membrane such as the GORE-TEX™ membrane (where GORE-TEX™ is the trade name and in certain countries the registered trademark of W.L. Gore & Associates Inc). A gas-permeable, liquid impermeable membrane is preferred due to the small size and high security of such membranes. The membranes typically have pores small enough for preventing liquid water molecules from passing through, but allowing gaseous CO₂ molecules to pass in both directions. One such membrane material is the well-known GORE-TEX™, which is made from extruded PTFE (polytetrafluorethylene).

According to a further embodiment of the first aspect, the beverage container and the dispensing device consist entirely of disposable and/or combustible polymeric materials. Since no suitable recycling facilities presently exist for larger beverage containers, the beverage container and said dispensing device preferably are combustible. The environmental concern is especially big for beverage dispensing assemblies constituting so-called party-kegs, since they may be used outdoors and by private users who may not be aware of the correct way to dispose of the empty container. Due to the relatively low pressures in the inner space, it will be preferred to use plastic materials or other polymers instead of metal. Plastic is less rigid than metal, but plastic may be easier disposed of, e.g. by combustion, and may therefore be handled by normal domestic and public recycling facilities.

According to a further embodiment of the first aspect, the beverage container is made of flexible material. Since the pressure in the inner space is low, the beverage container may be flexible, thereby saving on material costs. Typical thin containers may thus be used for the above purpose. Flexible containers are also used for bag-in-container, bag-in-box and similar using a collapsible beverage container.

According to a further embodiment of the first aspect, the mass of the particular amount of adsorbing material amounts to approximately 1%-10%, preferably 2%-5%, more preferably 3%-4%, of the initial mass of the carbonated beverage in the beverage space. It is preferred to use small canisters with adsorbing material since the canisters do not contribute to storing beverage and may thus be considered a waste since the beverage dispensing assembly must be manufactured and transported to the customer including the cartridges. On the other hand, large canisters including a large amount of adsorbing material will ensure a constant pressure in the inner space during the complete beverage dispensing. The amount of CO₂ being absorbed by the adsorbing material is dependent on the pressure and the mass of the adsorption material. Thus, it is clear that the mass of adsorption material is a trade-off between maintaining the pressure substantially constant and providing a small and light beverage dispensing assembly. It has been determined through experiments that having adsorption material with the above mass in relation to the mass of the beverage will, when loaded with CO₂, be suitable for substituting the beverage space with CO₂ and maintaining the pressure substantially constant while not contributing significantly to the weight and size of the beverage dispensing assembly.

According to a further embodiment of the first aspect, the adsorption material comprises activated carbon. Preferably, activated carbon is used as adsorption material, since it may adsorb and release sufficiently large amounts of CO₂ for satisfying the above requirements of having small canisters. Activated carbon also adsorbs and releases CO₂ in a sufficiently short amount of time for allowing a continuous dispensing of beverage and a quick response to changing of the temperature and pressure inside the beverage container.

According to a further embodiment of the first aspect, the specific amount of CO₂ initially adsorbed by the adsorbing material is equal to 1-3 times, preferably 1.5-2.5 times, more preferably 1.8-2 times the volume of the carbonated beverage in the beverage space at atmospheric pressure. To be able to substitute one litre of beverage by CO₂ at a sufficient pressure of about 1 bar above the atmospheric pressure, the adsorbing material must be pre-loaded with about 2 litres of CO₂. Having a smaller amount of CO₂ will inevitably cause a pressure reduction in the head space as the beverage space is reduced.

According to a further embodiment of the first aspect, the head space and/or the adsorption material further includes an inert gas being substantially non-reacting to the beverage and the CO₂, the inert gas may preferably be N₂ or alternatively any of the noble gases, or yet alternatively a mixture of the above. In some embodiments it may be desired to have a low carbonisation of the beverage, but a large driving pressure for efficient dispensation. By using CO₂ a high driving pressure would inevitably yield a high carbonisation of the beverage, at least when there is a direct fluid communication between the head space and the beverage space. One way of avoiding direct fluid communication between the beverage space and the head space is to use a collapsible container for the beverage space and collapsing the container by pressurising the head space outside the flexible container while dispensing. A preferred solution is to replace some CO₂ by an inert gas, e.g. N₂. N₂ will only contribute to pressurisation and not the carbonisation of the beverage, yielding the beverage with a high driving pressure and low carbonisation. It is contemplated that numerous inert gases, and in particular noble gases which do not influence the taste or composition of the beverage, may be used.

The above need and the above object together with numerous other needs and objects which will be evident from the below detailed description are according to a second aspect of the present invention obtained by a carbonisation canister for use in a beverage container according to any of the preceding claims, the beverage container when filled defining a head space and a beverage space for accommodating a carbonated beverage, the carbonisation canister having a specific density of less than 50% of the specific density of the beverage and defining a centre of gravity, the carbonisation canister comprising:
an outer wall,
a first opening,
a second opening being located opposite the first opening,
a channel interconnecting the first and second openings, the channel being substantially straight and including the centre of gravity of the carbonisation canister,
an inner chamber located between the channel and the outer wall, the inner chamber comprising a particular amount of adsorption material having adsorbed a specific amount of CO₂, the particular amount of adsorption material being inherently capable of regulating the pressure in the head space and capable of preserving the carbonisation of the carbonated beverage in the beverage space by releasing CO₂ into the head space, the specific amount of CO₂ being sufficient for allowing the head space to increase in volume and substituting the beverage space when the carbonated beverage having the specific temperature is being dispensed from the container by using the dispensing device and maintaining the initial pressure, or at least a pressure of 0.1-3 bar above the atmospheric pressure in the head space during the complete substitution of the beverage space by the head space, and
a hydrophobic labyrinth providing gaseous communication between the inner chamber and the head space for the adsorbing material to adsorb CO₂ from the head space or release CO₂ into the head space, the hydrophobic labyrinth having an entrance in the channel approximately at the centre of gravity of the carbonisation canister.

It is contemplated that the above canister according to the second aspect may be used in the above beverage dispenser assembly according to the first aspect. Locating the hydrophobic labyrinth having an entrance approximately at the centre of gravity of the carbonisation canister and provided the carbonisation canister having a specific density of less than 50% of the density of the carbonated beverage will allow the hydrophobic labyrinth to remain above the beverage surface independently of the orientation of the carbonisation canister. By providing the channel, the first opening and the opposite second opening, it can be ensured that at least one of the openings is facing the head space, thus providing gaseous access from the hydrophobic labyrinth to the head space. It is contemplated that providing a carbonisation canister having a specific density much lower than 50% of the beverage will cause the carbonisation canister to float high on the beverage surface and thus the entrance hydrophobic labyrinth may be located further away from the centre of gravity of the carbonisation canister. It is further contemplated that in a non-steady state situation, e.g. during transportation of the beverage container, the carbonisation canister and the entrance of the hydrophobic labyrinth may temporarily submerge into the beverage and temporarily prevent gaseous communication between the head space and the inner chamber.

The above need and the above object together with numerous other needs and objects which will be evident from the below detailed description are according to a third aspect of the present invention obtained by a method for producing a self regulating and constant pressure-maintaining beverage dispenser assembly by providing:
a flexible and compressible beverage container having an opening and defining an inner space for filling and accommodating a carbonated beverage, the inner space and the beverage container being variable between a compressed state and an uncompressed state, when filled with carbonated beverage the inner space defining a beverage space and a head space,
a dispensing device communicating with the beverage space, and
at least one carbonisation canister comprising a particular amount of adsorption material, the adsorption material being capable of adsorbing a specific amount of CO₂, the specific amount of CO₂ being sufficient for during beverage dispensing at a specific temperature of 2° C.-50° C., preferably 3° C.-25° C. and more preferably 5° C.-15° C. and an initial pressure of 0.1-3 bar above the atmospheric pressure allowing the head space to substitute the beverage space while maintaining the initial pressure, or at least a pressure of 0.1-3 bar above the atmospheric pressure, in the head space, the adsorption material being separated from the outside of the canister by a hydrophobic labyrinth, the hydrophobic labyrinth being initially sealed by a burst membrane having a specific burst pressure, the method comprising performing the steps of:
introducing the carbonisation canister into the beverage container.
introducing carbonated beverage through the opening into the inner space thereby establishing the beverage space and the head space, the beverage space communicating with the head space and the head space communicating with the carbonisation canister,
causing the beverage container and the inner space to assume the compressed state and substantially eliminating the head space, and
introducing a pre-determined amount of CO₂ at a specific pressure profile into the inner space while causing the beverage container to assume the uncompressed state for re-establishing the head space having the initial pressure and communicating with the carbonisation canister and the beverage space while the specific pressure profile at least at some instance exceeding the bursting pressure of the burst membrane for causing the burst membrane to rupture and the adsorption material in the canister to adsorb the specific amount of CO₂.

The above method according to the third aspect is preferred for manufacturing the above beverage dispenser assembly according to the first aspect at least for a small scale production facility. It is further understood that additional steps may be performed, i.e. flushing the inner space with CO₂ before filling with beverage for avoiding any oxygen molecules remaining during filling. The beverage container should be flexible and compressible at least for the above purpose of removing and establishing the head space. The particular amount of adsorbing material should be sufficient for allowing the specific amount of CO₂ to be adsorbed and released as the pressure in the head space sinks, e.g. by beverage dispensing. The specific amount of CO₂ should be sufficient for allowing the head space to increase its volume and the beverage space to reduce its volume while keeping the pressure in the inner space substantially constant for maintaining a carbonisation pressure and driving pressure. For some embodiments it may be sufficient to maintain 0.1-3 bar.

The hydrophobic labyrinth, which provides fluid communication between the adsorbing material and the head space, is initially sealed by a burst membrane for preventing air, in particular oxygen, from entering the canister and being adsorbed by the adsorption material. Oxygen which is adsorbed in the adsorption material may reduce the amount of CO₂ which the adsorption material may adsorb and act adversely on the beverage quality. Accordingly, the canister should be manufactured and sealed in an oxygen-free atmosphere. The beverage container is typically blow moulded and has an opening larger than the size of the canister. The canister is introduced into the beverage container through the opening before filling. After the canisters have been introduced the beverage container is typically flushed with CO₂ for creating a substantially oxygen-free atmosphere inside the beverage container. When the canister and the beverage have been introduced into the beverage container, the CO₂ pressure is increased for the seal of the canister to burst, which allows the adsorbing material inside the canister to absorb the specific amount of CO₂. The bursting pressure of the burst membrane and the pressure profile should be chosen according to the kind of carbonated beverage used and correspond to the carbonisation pressure of the beverage to avoid over- and under-carbonisation of the beverage. Pressures around 0.1-3 bar, typically 0.5-3 bar are considered to be appropriate for most carbonated beverage.

The beverage container should be filled in the compressed state for reserving a volume which may later constitute the head space. By filling the beverage container completely with beverage in the compressed state, a head space containing oxygen is prevented.

The head space should be established by connection to a CO₂ source to allow the canisters access to CO₂ and thus allowing the canisters the capability of adsorbing as well as releasing CO₂ for efficiently regulating the pressure inside the beverage container. The head space must be oxygen-free, thus the beverage container should be sealed directly before the establishment and pressurisation of the head space.

The above need and the above object together with numerous other needs and objects which will be evident from the below detailed description are according to a fourth aspect of the present invention obtained by a method for producing a self regulating and constant pressure maintaining beverage dispenser assembly by providing:
a flexible and compressible beverage container having an opening and defining an inner space for filling and accommodating a carbonated beverage, the inner space and the beverage container being variable between a compressed state and an uncompressed state, when filled with carbonated beverage the inner space defining a beverage space and a head space,
a dispensing device communicating with the inner space, and
at least one carbonisation canister comprising a particular amount of adsorption material, the adsorption material being pre-loaded with a specific amount of CO₂, the specific amount of CO₂ being sufficient for during beverage dispensing at a specific temperature of 2° C.-50° C., preferably 3° C.-25° C. and more preferably 5° C.-15° C. and an initial pressure of 0.1-3 bar above the atmospheric pressure allowing the head space to substitute the beverage space while maintaining the initial pressure, or at least a pressure of 0.1-3 bar above the atmospheric pressure, in the head space, the adsorption material being separated from the outside of the canister by a hydrophobic labyrinth, the hydrophobic labyrinth being initially sealed by a burst membrane having a specific burst pressure, the method comprising performing the steps of:
introducing the carbonisation canister into the beverage container.
introducing carbonated beverage through the opening into the inner space thereby establishing the beverage space and the head space, the beverage space communicating with the head space and the head space communicating with the carbonisation canister,
causing the beverage container and the inner space to assume the compressed state and substantially eliminating the head space,
introducing a pre-determined amount of CO₂ at a specific pressure profile into the inner space while causing the beverage container to assume the uncompressed state for re-establishing the head space having the initial pressure and communicating with the carbonisation canister and the beverage space while the specific pressure profile at least at some instance exceeding the bursting pressure of the burst membrane for causing the burst membrane to rupture.

In some cases it may be preferred to have the canister pre-loaded by allowing the canisters to adsorb pressurised CO₂ before being sealed. The burst membrane must then be modified to be able to withstand the internal pressure in the canister, while bursting when a suitable external pressure is applied, i.e. when the head space is applied. It is contemplated that by using a pre-loaded canister, the head space may be established faster, since the canisters must not adsorb any CO₂ at this stage.

The above need and the above object together with numerous other needs and objects which will be evident from the below detailed description are according to a fifth aspect of the present invention obtained by a method for producing a self regulating and constant pressure maintaining beverage dispenser assembly by providing a pressurised chamber having an initial CO₂ pressure of 0.1-3 bar above the outside ambient pressure, the method comprises the following steps to be performed within the pressurised chamber:
providing a beverage container having an opening and defining an inner space for filling and accommodating a carbonated beverage, when filled with carbonated beverage the inner space defining a beverage space and a head space,
providing a dispensing device communicating with the inner space,
providing at least one carbonisation canister comprising a particular amount of adsorption material, the adsorption material being pre-loaded with a specific amount of CO₂, the specific amount of CO₂ being sufficient for during beverage dispensing at a specific temperature of 2° C.-50° C., preferably 3° C.-25° C. and more preferably 5° C.-15° C. and the initial pressure of 0.1-3 bar above the atmospheric pressure allowing the head space to substitute the beverage space while maintaining the initial pressure, or at least a pressure of 0.1-3 bar above the atmospheric pressure, in the head space, the adsorption material being separated from the outside of the canister by a hydrophobic labyrinth,
introducing the carbonisation canister into the beverage container through the opening, and
introducing carbonated beverage through the opening into the inner space thereby establishing the beverage space and the head space, the beverage space communicating with the head space and the head space communicating with the carbonisation canister.

It is contemplated that the above method according to the fifth aspect may be used for manufacturing the above beverage dispenser assembly according to the first aspect and may be preferred for large-scale production. By performing the complete filling process in a pressurised CO₂ atmosphere, the need of a burst membrane and the step of compressing the beverage container for eliminating the head space may be omitted since it is not possible for any oxygen to enter the beverage container or canister.

The above need and the above object together with numerous other needs and objects which will be evident from the below detailed description are according to a sixth aspect of the present invention obtained by a method for producing a self regulating and constant pressure maintaining beverage dispenser assembly by providing:
a flexible and compressible beverage container having an opening and defining an inner space for filling and accommodating a carbonated beverage, the inner space and the beverage container being variable between a compressed state and an uncompressed state, when filled with carbonated beverage the inner space defining a beverage space and a head space,
a dispensing device communicating with the inner space, and
at least one carbonisation canister comprising a particular amount of adsorption material, the adsorption material being pre-loaded with a specific amount of CO₂, the specific amount of CO₂ being sufficient for during beverage dispensing at a specific temperature of 2° C.-50° C., preferably 3° C.-25° C. and more preferably 5° C.-15° C. and an initial pressure of 0.1-3 bar above the atmospheric pressure allowing the head space to substitute the beverage space while maintaining the initial pressure, or at least a pressure of 0.1-3 bar above the atmospheric pressure, in the head space, the adsorption material being separated from the outside of the canister by a hydrophobic labyrinth, the canister being initially kept in a CO₂ atmosphere at the initial pressure, the method comprising performing the steps of:
introducing carbonated beverage through the opening into the inner space thereby establishing the beverage space and the head space, the beverage space communicating with the head space,
causing the beverage container and the inner space to assume the compressed state and substantially eliminating the head space,
introducing a pre-determined amount of CO₂ at a specific pressure profile into the inner space while causing the beverage container to assume the uncompressed state for re-establishing the head space having the initial pressure and communicating with the beverage space,
introducing the carbonisation canister into the head space while permanently keeping the carbonisation canister at the CO₂ atmosphere at the initial pressure.

In a further alternative manufacturing method, the canisters may be introduced after the beverage container has been filled with beverage and the head space has been established. By introducing the canisters under pressure, the need of the burst membrane may be eliminated.

### BRIEF DESCRIPTION OF THE DRAWINGS

A brief description of the figures follows below:

FIG. 1A is a first embodiment of a beverage dispensing assembly according to the present invention,

FIG. 1B is a second and presently preferred embodiment of a beverage dispensing assembly according to the present invention,

FIG. 2A-I is the filling of the beverage keg according to the present invention,

FIG. 3A-C is the installation of a dispensing device on the beverage keg,

FIG. 4A-B is a cut-out view of the canister being located inside the beverage keg,

FIG. 5 is a perspective view of the canister,

FIG. 6A-H is a further embodiment of the filling of the beverage keg according to the present invention,

FIG. 7A-F is yet a further embodiment of the filling of the beverage keg according to the present invention,

FIG. 8 is yet an alternative embodiment of the beverage dispensing assembly according to the present invention,

FIG. 9A-B is the results of the first proof-of-concept experiments performed with the above experimental setup,

FIG. 10 is an alternative embodiment of the beverage dispensing assembly having a canister fixed to the tapping hose and a manually operated piercing element,

FIG. 11 is an alternative embodiment of the beverage dispensing assembly where the tapping hose is provided separately having a rupturable membrane,

FIG. 12 is an alternative embodiment of the beverage dispensing assembly where the tapping hose is provided separately having a burst membrane,

FIG. 13 is an alternative embodiment of the beverage dispensing assembly where the tapping hose is omitted, and

FIG. 14 is an alternative embodiment of the beverage dispensing assembly where the outer wall of the canister is made entirely of hydrophobic material.

### DETAILED DESCRIPTION

A detailed description of the figures follows below:

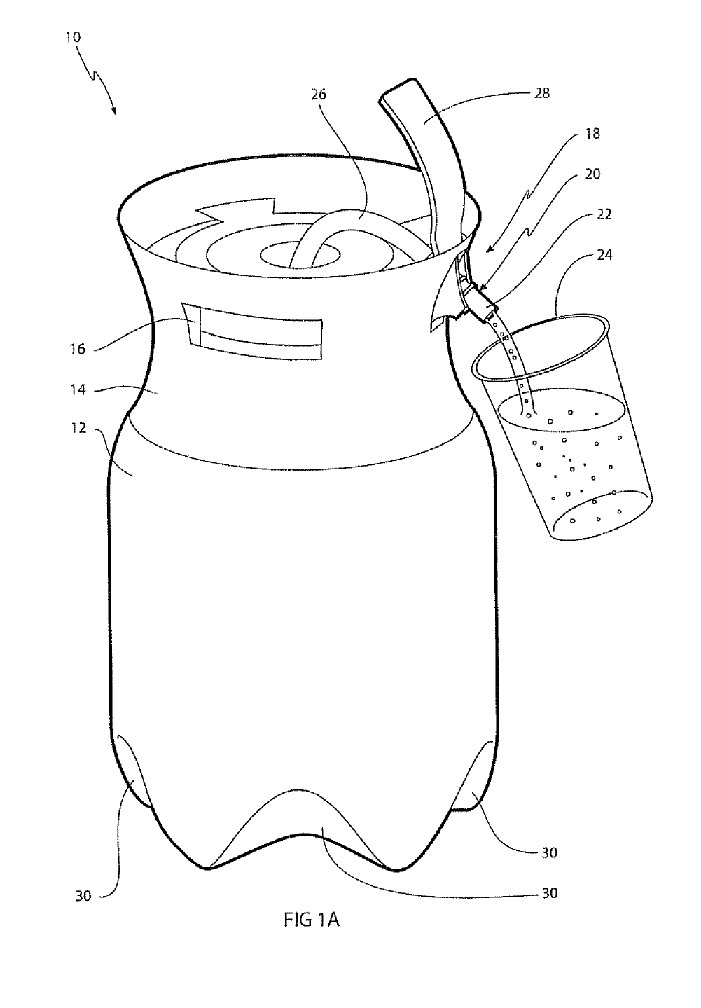

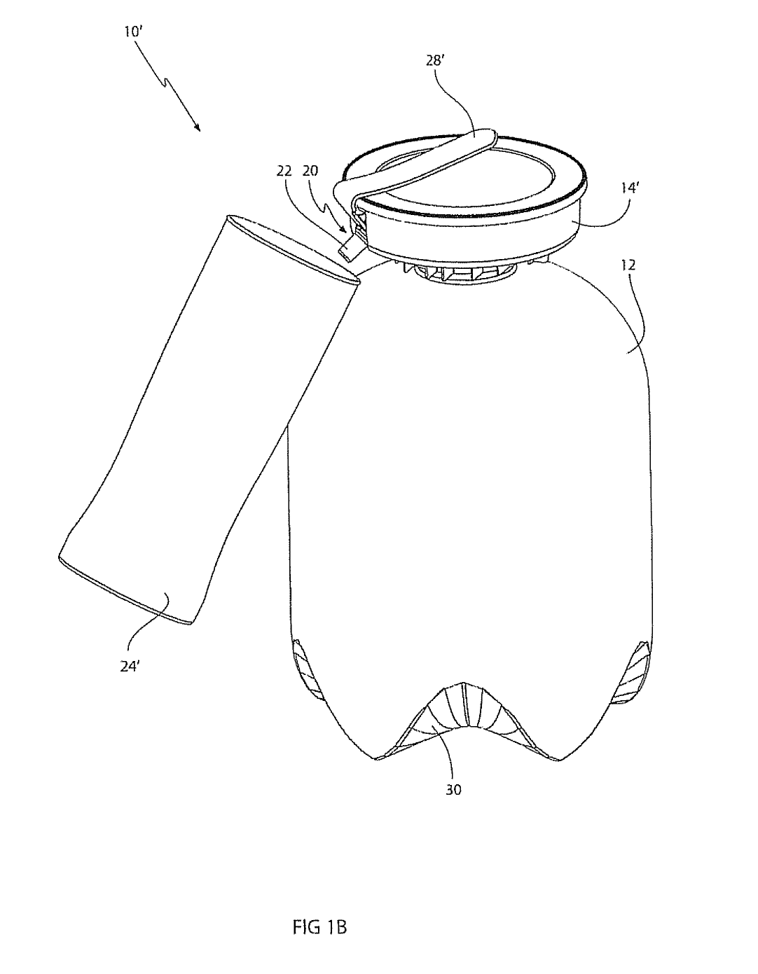

FIG. 1A shows a first embodiment of a beverage dispenser assembly 10 according to the present invention. The beverage dispenser assembly 10 constitutes a so-called mini-keg or party-keg useful for minor social events as described above and includes a beverage container 12 filled with a carbonated beverage such as any carbonated beverage of the following kinds: beers, ciders, cocktails, champagnes, alcopops etc and soft drinks such as tonics, colas and mineral waters. Beers are further understood to comprise pilsners, lagers, ales, stouts, porters etc. The beverage container 12 is blow moulded of plastic material, such as PET plastic, and typically has a size of about 6 litres. The beverage container 12 has an attached circular frame 14 attached to and encircling the upper portion of the beverage container 12. The frame 14 has a grip 16 defining a hole in the frame for easy transport of the beverage dispenser assembly 10.

The frame 14 further includes a dispensing device 18. A tapping valve 20 is accommodated in the dispensing device 18. The tapping valve 20 has an outwardly/downwardly oriented beverage outlet 22 from which carbonated beverage may flow into a glass 24 during beverage dispensing. A beverage hose 26 is connected between the tapping valve 20 and the beverage container 12 for allowing beverage to flow from the beverage container 12 to the tapping valve 20. The beverage hose 26 is detachable and made of flexible polymeric material. The tapping valve 20 is controlled by a tapping handle 28. When the tapping handle 28 is operated, beverage will flow from the beverage container 12, via the beverage hose 26 and tapping valve 20 out through the beverage outlet 22. The lower portion of the container 12, opposite the frame 14, comprises five slots 30, constituting inwardly bulges for providing a stable base for the beverage container 12.

In FIG. 1B, a modified beverage dispensing assembly 10′ is shown, constituting a presently preferred embodiment of the beverage dispensing assembly according to the present invention. In the second embodiment of the beverage dispensing assembly 10′ shown in FIG. 1B the same components as described above with reference to FIG. 1A are designated the same reference numerals as described above and components or elements serving the same purpose as components or elements, respectively, described above, however, having different configuration, are designated the same reference numerals as used above, however, added marking in order to identify the difference in appearance.

The second and presently preferred embodiment of the beverage dispensing assembly basically differs from the above described first embodiment in that the frame 14 is omitted and substituted by a closure part 14′ in which the dispensing device is included having the beverage outlet 22 of the tapping valve extending outwardly from the closure part 14′ through a side wall aperture of the closure part. Like the above described first embodiment of the beverage dispensing assembly according to the present invention, the second and presently preferred embodiment includes a handle 28′ serving to operate the valve for dispensing beverage into a glass 24′. Apart from the above difference by the substitution of the frame 14 of the first embodiment shown in FIG. 1A by the closure part 14′ of the second embodiment shown in FIG. 1B, the beverage container 12 as such is identical to the above described first embodiment shown in FIG. 1A.

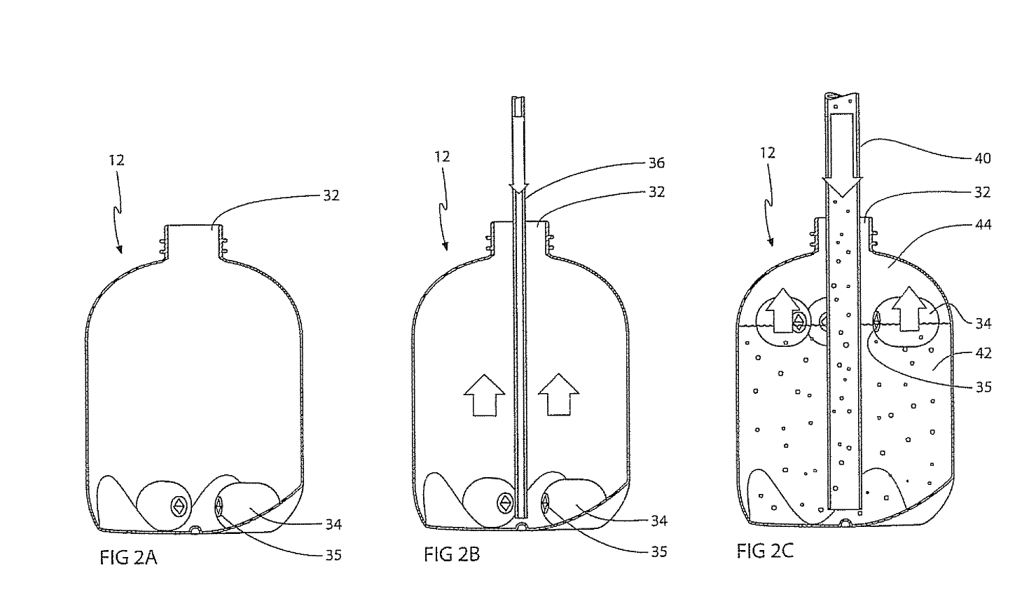

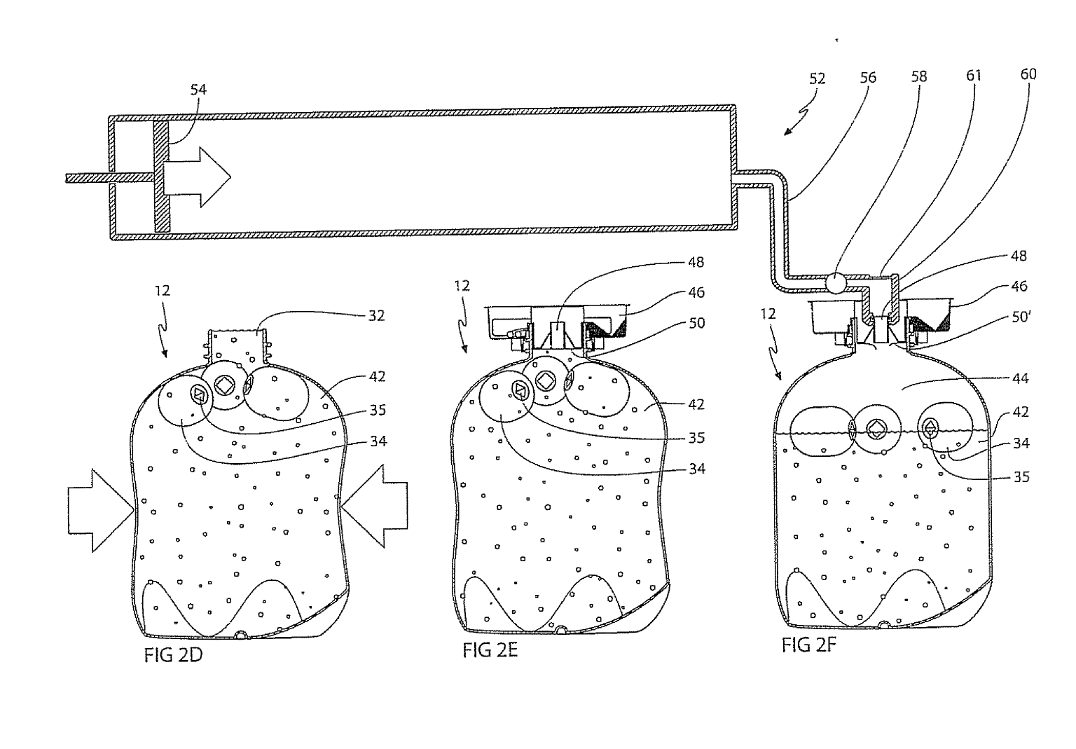

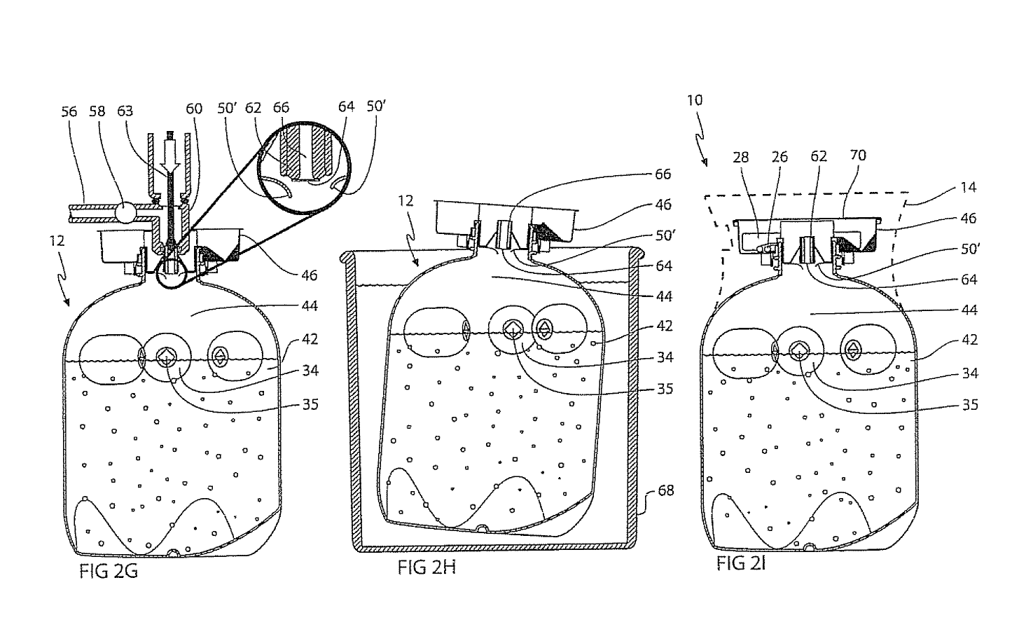

FIG. 2A shows a beverage container 12 before the filling process is initiated. The container 12 comprises an opening 32 for accessing the interior of the beverage container 12. The interior of the beverage container 12 further comprises five canisters 34 for controlling the pressurisation of the beverage container 12 during use and for compensating head space during use. The canisters 34 each comprise a channel 35 leading through the canister 34. The interior of the canister 34 is filled by an adsorption material. The channel 35 is initially separated from the adsorption material by a burst membrane (not shown) which is designed to burst when subjected to an overpressure of about 1 bar. The functional principle of the canister 34 will be further described later. The canisters 34 are introduced through the opening 32 and initially rest inside the beverage container 12 at the slots 30.

FIG. 2B shows the CO₂ flushing of the beverage container 12. The beverage container 12 is flushed by using a CO₂ flushing pipe 38 which is connected to an external CO₂ source (not shown) which forms part of a beverage filling station (not shown). The CO₂ pipe 38 is introduced through the opening 32 into the beverage container 12 and the beverage container 12 is flushed twice with CO₂ by applying a gas flow of CO₂ through the CO₂ filling pipe into the beverage container 12. Since CO₂ has a higher specific density than the surrounding air, the air will be ejected from the beverage container 12 and the CO₂ will remain inside the beverage container 12. The CO₂ flushing of the beverage container 12 serves the purpose of avoiding any oxygen containing air bubbles to remain inside the beverage container 12 when filled with beverage, as will be described later. Oxygen remaining inside the beverage container 12 may cause the beverage to deteriorate.

FIG. 2C shows the beverage container 12 being filled with beverage. The beverage container 12 is filled by using a beverage filling pipe 40 which forms a part of the beverage filling station (not shown). As the beverage enters the beverage container 12 the canisters 34 having a specific density, which is lower than the beverage, will float in a partially submerged state at the upper portion of the beverage container 12. The beverage is saturated with carbon dioxide and kept at a temperature of 10-15° C. At such low temperatures, a greater amount of carbon dioxide may be dissolved in the beverage compared to the amount of dissolved CO₂ at room temperature. The beverage container 12 is filled with about 5 litres or ⅚ of its total volume of beverage 42. A head space 44 of about 1 litre or ⅙ of the total volume of the beverage container 12 remains at the opening 32. In an alternative embodiment, the flushing tube 38 and the filling tube 40 may be constituted by one and the same tube.

FIG. 2D shows the compression of the beverage container 12. By applying a force onto the side of the beverage container 12, the volume of the beverage container 12 is reduced and the head space disappears as the beverage is level with the opening 32.

FIG. 2E shows the application of a closure part 46, similar to the closure part 14′ described above with reference to FIG. 1B, onto the opening 32 of the beverage container 12. The beverage container 12 is maintained in a compressed state, thus preventing the formation of a head space. The closure part 46 is sealed permanently and fluid tightly onto the beverage container 12. The closure part 46 has a centrally located passage 48 at the opening 32 providing access to the beverage container 12,

The passage 48 is initially sealed by a rupturable membrane 50. The rupturable membrane may be designed to burst at a certain pressure difference, such as 1 bar, or alternatively be pierceable.

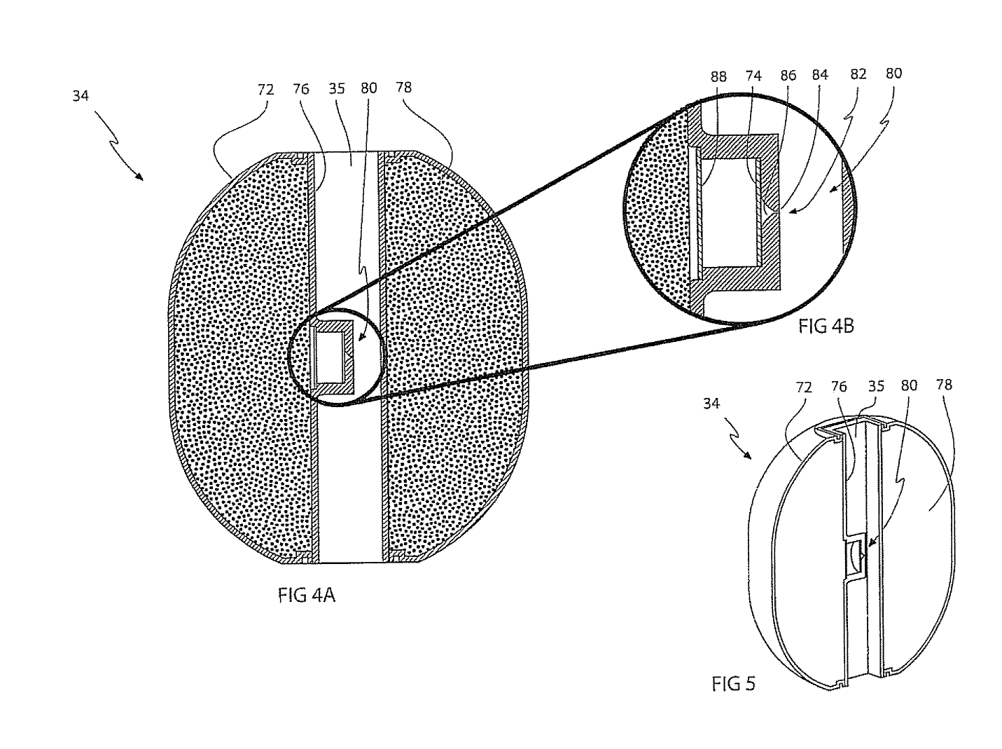

FIG. 2F shows the pressurisation of the beverage container 12 by using a pressurisation device 52. The pressurisation device 52 is filled with a specific volume of CO₂ amounting to 1.8 litres of atmospheric pressurised CO₂ per litre of beverage. In the present example, the pressurisation device 52 is filled with nine litres of CO₂ being sufficient for five litres of beverage. The pressurisation devices 52 comprise a piston 54 for compressing the specific amount of CO₂ inside the pressurisation device 52 and an oppositely located pressurisation pipe 56. The pressurisation pipe 56 is connected to the passage 48 of the closure part 46 via a non-return valve 58 and a connector 60. The connector 60 has an access port 61 for inserting a plug for sealing the passage into the beverage container 12. When the pressure of the CO₂ in the pressurisation device 56 increases, the rupturable membrane 50′ will burst and CO₂ will enter the beverage container 12. As the CO₂ enters the beverage container 12 from the pressurisation device 52 the head space 44 will form again and the beverage container 12 will re-assume its initial uncompressed state. In order to allow the canisters to stand pressure variations during the process of filling the beverage container 12 and pressurizing the head space, the canisters are designed to be able to stand a safe excess pressure such as the pressure of 3 bar without causing the burst membranes of the canisters to burst as will be described below with reference to FIGS. 4A and 4B. For allowing the burst membranes of the canisters 34 to break and thereby initiate the canisters, the pressure inside the beverage container must be raised above the above-mentioned safe pressure to a pressure of e.g. 5 bar, i.e. 2 bar above the safe pressure for ensuring the activation of all the canisters 34. The canisters 34 will when activated adsorb a large portion of the CO₂ inside the beverage container 12 and quickly reduce the pressure inside the container 12 to about 0.5-1.5 bar. Failure to initiate all of the canisters 34 will lead to excessive pressure inside the beverage container 12 and possible over-carbonisation of the beverage.

In an alternative embodiment, the canisters 34 may be pre-loaded with pressurised CO₂ of about 0.5-1.5 bar and caused to adsorb said specific volume of CO₂ as described above before the pressurisation step is initiated. Such canisters 34 may have a rupturable membrane, which may hold the internal pressure of 0.5-1.5 bar while rupturing when subjected to an outside pressure of about 0.5-1.5 bar. In this way, it will not be necessary to introduce the specific amount of CO₂ at the pressurisation step; it is merely required to reach a sufficient pressure for the membrane to burst. Since some time is needed for loading the canisters 34 with CO₂, the use of pre-loaded canisters 34 may sometimes accelerate the manufacturing process.

FIG. 2G shows the application of a plug 62 into the passage 48 of the closure part 46 by use of a plug actuator 63. The plug 62 comprises a pierceable membrane 64. The plug 62 is applied while maintaining the beverage container 12 under pressure from the pressurisation pipe 56. The plug 62 and the plug actuator 63 are introduced via the access port 61 of the connector 60. The plug 62 comprises a feed-through conduit 66, which is separated from the beverage by the pierceable membrane 64. The plug 62 is sealed to the passage 48 permanently and fluid tightly. The plug 62 is introduced through the access port 61 and put in place by the plug actuator 63.

FIG. 2H shows the beverage container 12 being subjected to a pasteurisation device 68. The pasteurisation is a well-known process, in which the beverage is heated to about 70° C. in a hot bath for killing the major part of the microorganisms in the beverage to increase the shelf-life of the beverage. During pasteurisation, the increase in the temperature will cause the pressure in the beverage container 12 to increase as well. When the pressure increases, the canisters 34 will absorb more CO₂, thus the total pressure increase will be reduced compared to not using the canisters 34. Thus, a less rigid beverage container 12 may be used which may save some material compared to previous beverage kegs needing to endure a large pressure during pasteurisation.

FIG. 2I shows the final beverage dispenser assembly 10. The beverage dispenser assembly 10 including the container 12, the closure part 46 and a beverage hose 26 provided in a coiled state inside the closure part 46. The frame 14 as shown in FIG. 1 may optionally be applied around the closure part for simplifying transportation of the beverage dispenser assembly 12, for allowing stacking a plurality of beverage dispenser assemblies on top of each other and for aesthetic purposes. The closure part may subsequently be sealed off by a removable tab (not shown) for hygienic reasons and for preventing the beverage hose 26 from falling out.

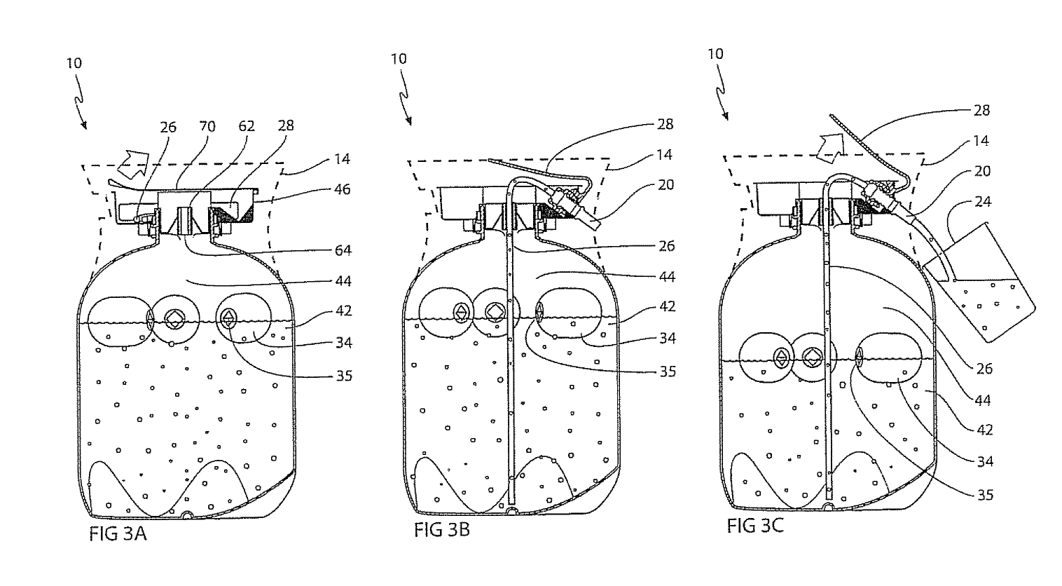

FIG. 3A shows the beverage dispenser assembly 10 in the packaged state before being prepared for beverage dispensing by a user, such as the beverage consumer or a person designated to dispense beverages, e.g. a bartender. The beverage hose 26 is provided in a coiled state in the frame 14. The first step of preparing the beverage dispenser assembly 10 is to place the dispenser 10 in an upright position at a suitable beverage dispensing location, such as on a bar counter or similar. The user removes the tab 70 for accessing the beverage hose 26 inside the closure part 46.

FIG. 3B shows the beverage dispenser assembly 10 when being prepared for beverage dispensing by the customer. One end of the beverage hose 26 comprises the tapping valve 20. The tapping valve 20 is fixed or may be fixed to the closure part 46. The customer uncoils the beverage hose 26 and introduces it through the conduit 66 of the plug 62, thereby piercing the pierceable membrane 64. The conduit 66 provides a pressure tight connection between the beverage hose 26 and the closure part 46. The beverage hose 26 should be long enough to reach the bottom of the beverage container 12 for being able to dispense the beverage completely. Alternatively, a short beverage hose 26 may be used in combination with an ascending pipe (not shown) preinstalled or separately provided inside the beverage container 12. Yet alternatively, the beverage dispenser assembly may be used in an upside down orientation, eliminating the need for fluid communication with the bottom of the beverage container 12 for allowing a complete dispensing of the beverage.

The tapping valve 20 has an extended state constituting a beverage dispensing position and a compressed state constituting a non-beverage dispensing (closed off) position. Such tapping valves are well-known in the prior art from e.g. EP 1 982 951. A handle 28 is provided for controlling the tapping valve 20. The handle 28 may be provided in the closure part 46 and be installed by the user during preparation of the beverage dispenser assembly 10. The handle 28 initially assumes a substantially horizontal orientation and is pivotally connected to the frame 14 at the tapping valve 20. The handle 28 cooperates with the tapping valve 20 so that when the handle 28 is in the horizontal position, the tapping valve 20 is in the contracted non-dispensing position preventing beverage dispensing from the beverage container 12.

In alternative embodiments or variants of the above described beverage dispensing assembly 10 shown in FIG. 3B, the plug 62 may be substituted by a dispensing tube extending to the position of the beverage hose 26 shown in FIG. 3B as the beverage hose 26 is to be received within the dispensing tube which is initially sealed off by a pierceable membrane at the bottom of the dispensing tube similar to the pierceable membrane 64 of the plug 62 shown in FIG. 3A. Alternatively, a loose dispensing tube may be used prior to the insertion of the beverage hose 26 into the dispensing tube which is initially introduced through the plug 62 for piercing the pierceable membrane 64 as the dispensing tube is at its lower end provided with a further pierceable membrane which is to be pierced by the beverage 26 as the hose is introduced into the beverage tube. Further alternatively, the dispensing tube substituting the plug 62 or serving to be introduced into the plug and piercing the pierceable membrane 64 prior to the mounting of the beverage hose 26 in the dispensing tube may be provided with a top sealing check valve (not shown) to which the beverage hose is to be connected as the beverage hose is of a reduced length as compared to the beverage hose 26 shown in FIG. 3B.

FIG. 3C shows the beverage dispenser assembly 10 during dispensing of beverage. When the handle 28 is pivoted from the substantially horizontal orientation to a substantially vertical orientation, the tapping valve 20 is extended to its beverage dispensing position and allows beverage to flow from the beverage container 12 via the beverage hose 26 and through the dispensing valve 20 and to the outlet 24. The pressure in the beverage container 12 is elevated in relation to the outside ambient pressure and the elevated pressure causes the beverage to flow out of the beverage container 12 when the tapping valve 20 is in the beverage dispensing position. The pressure in the beverage container 12 is typically 0.8 bar above ambient pressure for allowing sufficient dispensing pressure and carbonisation pressure for allowing the beverage to remain carbonated. When beverage is dispensed, the head space 44 in the beverage container 12 will increase in volume, and consequently the pressure in the beverage container will decrease. As the pressure in the beverage container decreases, the CO₂ stored inside the canisters 34 will dissipate and compensate for the pressure loss in the beverage container 12. The pressure in the beverage container 12 may thus be held substantially constant during beverage dispensing and when the beverage container is empty, the overpressure in the beverage container 12 should still amount to about 0.5-0.6 bar. The tapping valve 20 may include a spring mechanism or the like (not shown), so that when the handle 28 is released, the dispensing valve 20 automatically assumes the non-beverage dispensing position.

FIG. 4A shows a cut-out view of the canister 34 according to the present invention. The canister 34 has an outer wall 72 and defines a shape resembling an ellipsoid and defining a proximal end and a distant end. The canister 34 defines a straight pass-through channel 35 penetrating through the outer wall 72 from the proximal end to the distant end of the canister 34 and defining an inner wall 76. The outer wall 72 and the inner wall 76 define an inner chamber 78 between them which is fluid tightly separated from the outside and which inner chamber 78 is filled with activated carbon. The total amount of activated carbon suitable for maintaining the pressure inside the above described beverage container including 5 litres of carbonated beverage and 1 litre of head space has been determined to be between 100 g and 500 g and preferably between 120 g and 135 g. In the channel 35 and at half distance between the proximal and distant ends an initiator 80 is located. The initiator 80 is further described below. The density of the canister 34 should be less that 50% of the density of the beverage.

Typically, the canister 34 has a density of 0.42-0.45 times the density of the beverage. The canister will thus float in the beverage having a greater portion of the outer wall 72 above the beverage surface. The total volume of the canisters will thus amount to around 300 ml, which will fit into the above-mentioned 1 litre of head space. Since the initiator 80 is located close to the centre of gravity of the canister 34 it will always remain above the beverage surface, at least in a non-moving, steady state situation. At least one of the proximal and distant ends of the canister 34 will also be above the beverage surface allowing the channel 35 and the activator 80 gaseous communication with the head space of the beverage container.

FIG. 4B shows a close-up view of the initiator 80 of the canister 34 as shown in FIG. 4A. The initiator 80 defines a nozzle 82 for interconnecting the channel 35 and the inner chamber 78 of the canister 34. The nozzle 82 serves as a flow restrictor to limit the gas flow between the channel 35 and the inner chamber 78. The nozzle 82 defines an orifice 84 having a sharp edge at the interface with the channel 35 and a smoothly converging nozzle part 86 at the opposite side of the nozzle 82 facing the inner chamber 78, thereby yielding a stronger maximum gas flow from the inner chamber 78 towards the channel 35 than from the channel 35 to the inner chamber 78. This effect is due to the flow separation at the edge of the orifice 84, which will further restrict an inwardly gas flow from the channel 35 towards the inner chamber 78. Outwardly gas flow from the inner chamber 78 towards the channel 35 will be able to pass less restricted due to the smoothly converging nozzle part 86 preventing flow separation inside the nozzle 82.

Between the nozzle 82 and the inner chamber 78 a burst membrane 74 is located. The burst membrane 74 prevents gas exchange between the inner volume 78 and the channel 35 before the canister 34 has been initiated. In the pre-initiation state, the burst membrane seals the inner chamber 78 fluid tight for preventing atmospheric gasses to enter the inner chamber 78 and to be adsorbed by the activated carbon before the canister 34 has been initiated inside the beverage container. The canister 34 may be initiated by applying a high pressure difference of at least 1 bar and preferably about 5-7 bar between the channel 35 and the inner chamber 78 which will result in the burst membrane 74 rupturing and allowing fluid communication between the channel 35 and the inner chamber 78 via the nozzle 82. The burst membrane 74 may be made of a thin foil of plastic or alternatively metal.

Between the burst membrane 74 and the inner chamber 78 a hydrophobic membrane 88 is located. The hydrophobic membrane 88 should be of the type being substantially impermeable to liquids, in particular water, and solids and at least substantially permeable to gasses, in particular CO₂. The hydrophobic membrane should act as a hydrophobic labyrinth preventing beverage from contacting the activated carbon inside the inner chamber 78. One suitable material exhibiting the above feature of being a hydrophobic labyrinth and thus being particular suitable for the above purpose is the well-known GORE-TEX™ material, commonly used in breathable/waterproof clothing. The hydrophobic membrane 88 allows gas exchange between the channel 35 and the inner chamber 78 while preventing any beverage to enter the inner chamber 58. Beverage entering the inner chamber 58 would adversely affect the activated carbon 58 inside the inner chamber. The initiator 80 will normally in a steady state situation be situated above the beverage surface, however, e.g. during transport the beverage container may be shaken and the initiator 80 may be temporarily submerged. In case of a temporary submersion of the initiator 80 the hydrophobic membrane 70 prevents beverage from entering the inner chamber 78.

FIG. 5 shows a perspective view of the canister 34 of FIG. 4. The inner wall 76 and the outer wall 72 are preferably made of a plastic material, which does not negatively affect the beverage, and in particular the same material is used for both the beverage container and the inner wall 76 and the outer wall 72. The canister 34 should have a specific density less than 50% of the beverage density. The canister 34 will thus float in the beverage and the initiator 80 being positioned near the centre of gravity of the canister 34 will therefore always be located above the surface of the beverage, at least in a steady state situation. The initiator 80 will therefore always be in contact with the CO₂ gas in the head space of the beverage container.

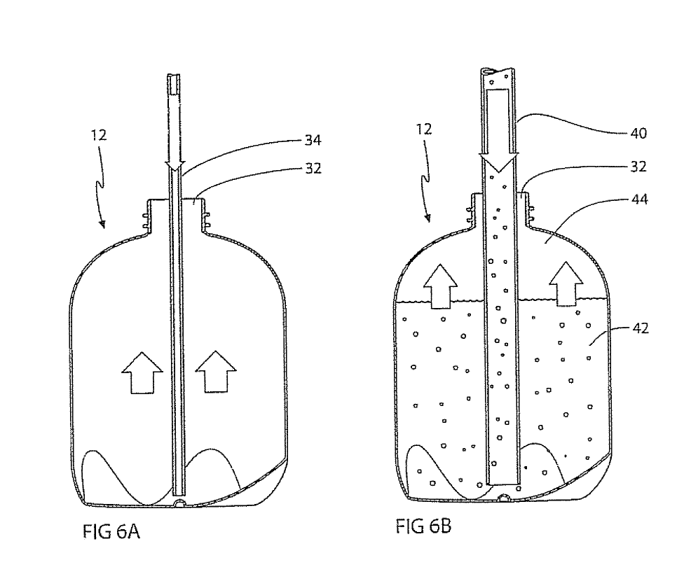

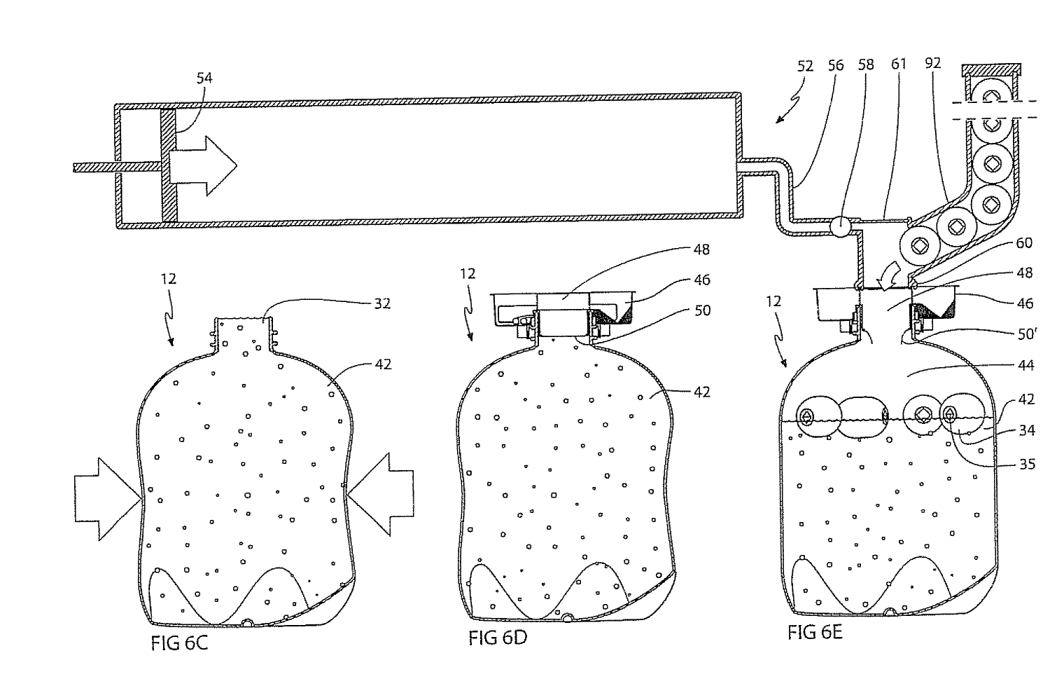

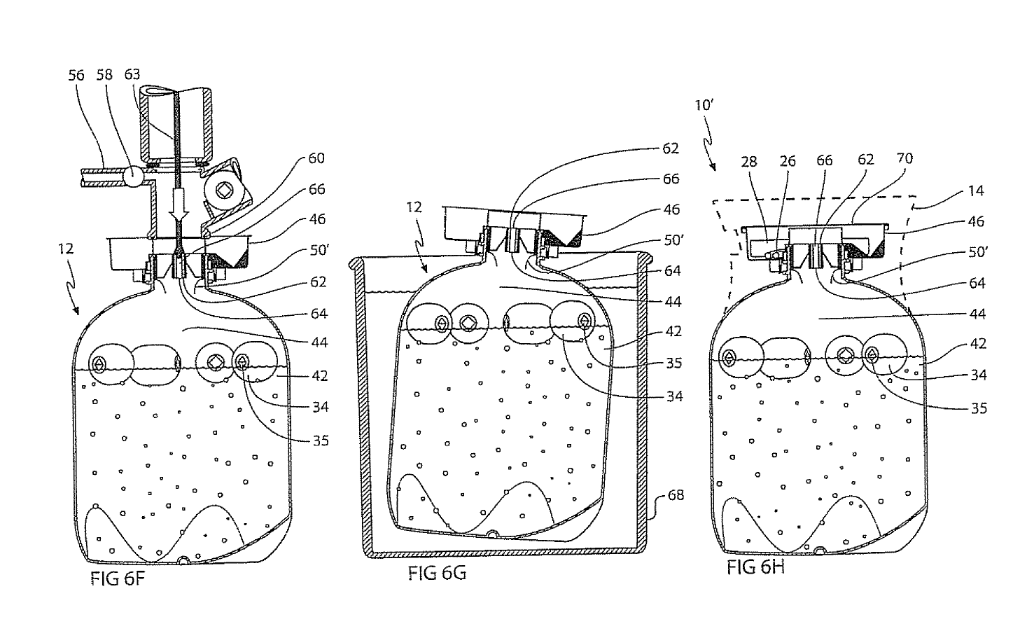

FIGS. 6A-6H show an alternative filling process, in which the burst membrane on the canister may be omitted and where the canister may be pre-filled with CO₂

FIG. 6A shows the CO₂ flushing of the beverage container 12 similar to FIG. 2B. It should be noted that the beverage container 12, in contrasting with FIG. 2B, does not include any canisters 12 at the present stage.

FIG. 6B shows the beverage container 12 being filled with beverage as already described in connection with FIG. 2C.

FIG. 6C shows the compression of the beverage container 12 for eliminating the head space as already described in connection with FIG. 2D.

FIG. 6D shows the application of a closure part 46 onto the opening 32 similar to FIG. 2E. It should be noted that the passage 48 in the closure part 46 is considerably larger than that of FIG. 2E for allowing the introduction of canisters in the subsequent step.

FIG. 6E shows the pressurisation of the beverage container 12 by using a pressurisation device 52 and the simultaneous introduction of canisters 34 by using a canister injector 92 which is being coupled to the pressurisation device 52. The functionality of the pressurisation device 52 has already been described in connection with FIG. 2F. As the CO₂ enters the beverage container 12 from the pressurisation device 52, the head space 44 will be re-established and the beverage container 12 will re-assume its initial uncompressed state. When the head space 44 has been established and pressurised, the canisters 34 may be released from the canister injector 92 into the beverage container 12. The canisters 34 may be stored in a pre-loaded state under CO₂ pressure inside the canister injector 92 in which case the pressurisation device must only generate a sufficient pressurisation of the head space. Alternatively, the canisters 34 may be stored in an atmospheric pressure of CO₂ in which case the pressurisation device must also be capable of loading the canisters 34 for delivering the specific amount of CO₂ allowing substitution of the beverage. Typically, the specific amount of CO₂ will be injected into the beverage container and the canisters 34 will adsorb a large portion of the CO₂ inside the beverage container 12 and quickly reduce the pressure inside the container 12 to about 0.5-1.5 bar. Since the canisters 12 are stored in a CO₂ atmosphere, the canisters must not be sealed by a burst membrane and the risk of failure to initiate all of the canisters 34 and the resulting excessive pressure inside the beverage container 12 and possible over-carbonisation of the beverage may be avoided.

FIG. 6F shows the application of a plug 62 into the passage 48 of the closure part 46, similar to FIG. 2G. The plug 62 of the present embodiment is considerably larger than the plug of FIG. 2G for sealing the larger passage 46.

FIG. 6G shows the beverage container 12 being subjected to a pasteurisation device 68 as shown in FIG. 2H.

FIG. 6H shows the final beverage dispenser assembly 10′ being similar to the beverage dispensing assembly 10′ of FIG. 2I.

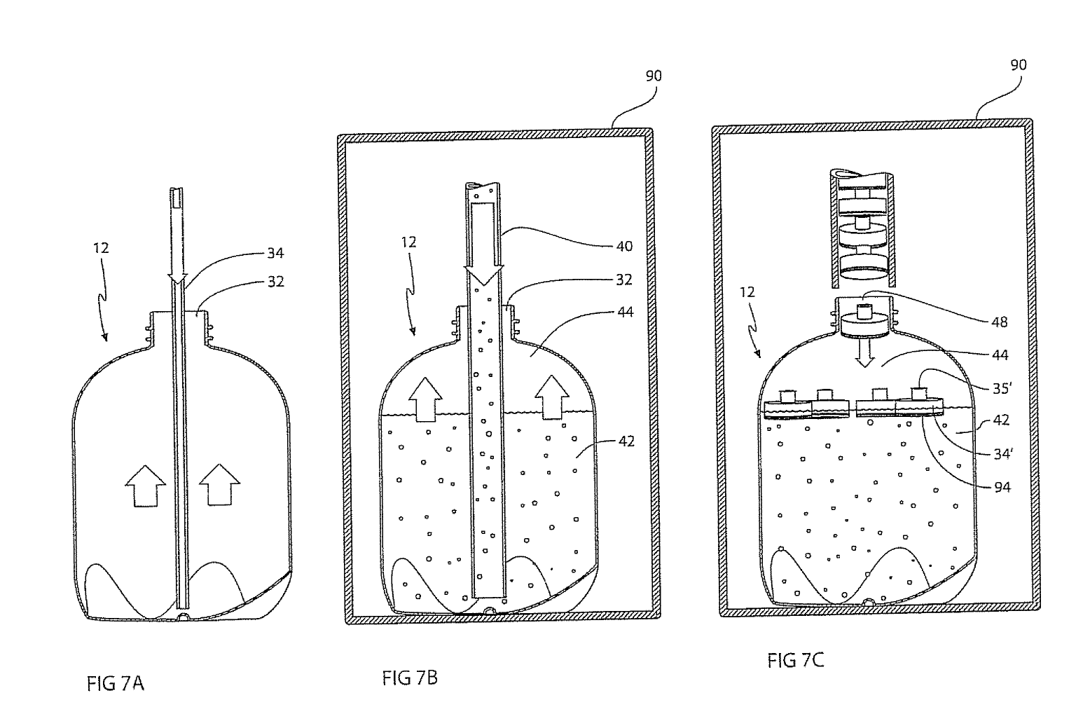

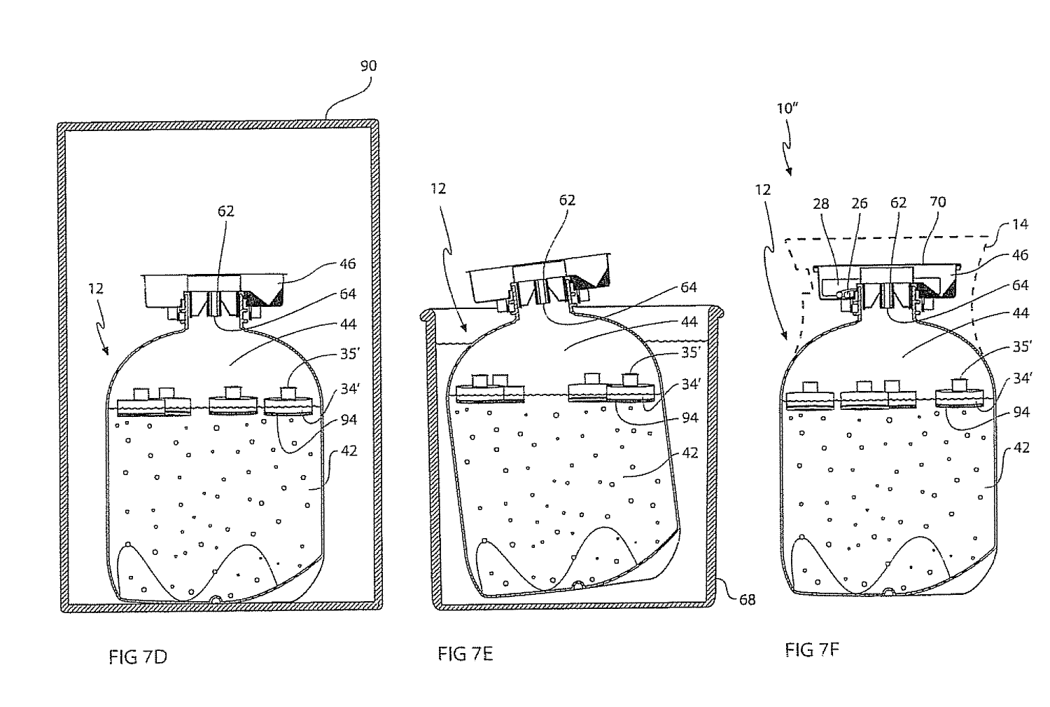

FIGS. 7A-7F show yet an alternative filling process especially suitable for large-scale production facilities, in which the burst membrane of the canister may be omitted and where the canister may or may not be pre-filled with CO₂

FIG. 7A shows the CO₂ flushing of the beverage container 12 similar to FIG. 2B. It should be noted that the beverage container 12, in contrast with FIG. 2B and similar to FIG. 6A, does not include any canisters 12 at the present stage.

FIG. 7B shows the beverage container 12 being filled with beverage as already described in connection with FIG. 2C. The beverage filling is performed within a pressure chamber 90. The pressure chamber 90 maintains a CO₂ atmosphere at a pressure of about 0.5-1.5 bar, which corresponds to the suitable dispensing pressure in the head space. In this way the intermediate stage of compressing the beverage container 12 may be omitted.

FIG. 7C shows the introduction of canisters 34′ into the beverage container 12 inside the pressure chamber 90. The canisters 34′ may be stored in a pre-loaded state under CO₂ pressure inside the pressure chamber 90, in which case the burst membrane may be omitted. Alternatively, the canisters 34 may be stored in an atmospheric pressure of CO₂, or otherwise separated from oxygen, e.g. by a burst membrane. When introduced into the pressure chamber 90 the adsorbing material of the canisters 34′ will adsorb the specific amount of CO₂ allowing substitution of the beverage.

The present embodiment features an alternative design of the canisters 34′ having a specific density larger than 50% of the specific density of the beverage and a raised channel 35′ which is intended to remain above the beverage surface in the head space 44, at least in a steady state situation. The centre of mass of the canister 34 should be located opposite the channel 35′ for allowing the canister to assume a substantial upright position when in the steady state situation. A weight 94, such as a piece of heavy plastic, may be placed opposite the channel 35′ for providing additional stability to the canister 34′.

FIG. 7D shows the application of a closure part 46′ onto the opening 32 similar to FIG. 2E while maintaining the beverage container 12 inside the pressure chamber 90. The closure part includes the plug 62 and the pierceable membrane 64 for sealing the opening 32 of the beverage container 12. It should be noted that the rupturable membrane may be omitted in the present closure part 46′. After application of the closure part 46′ and the sealing of the beverage container 12 under pressure the beverage container 12 may be removed from the pressure chamber 90.

FIG. 7E shows the beverage container 12 being subjected to a pasteurisation device 68 as shown in FIG. 2H.

FIG. 7F shows the final beverage dispenser assembly 10″ similar to FIG. 2I.

FIG. 8 shows yet an alternative embodiment being a reusable beverage dispenser assembly 100, which is intended for multiple use and especially suitable for use in smaller professional establishments. The beverage dispenser assembly 100 comprise a canister (reusable) 102 made of metal or plastic or similar rigid material. The canister 102 is filled with adsorption material, presently activated carbon. The canister 102 is connected to a cylinder 104. The cylinder 104 is filled with CO₂ and constituting the initial head space. The cylinder 104 is connected to a beverage reservoir 112 via a pressure valve 110. The connections are made by pressure tight tubing 108. The beverage reservoir 112 constitutes the beverage space and is initially completely filled with beverage by opening a pressure lid 113. The beverage may be selectively dispensed via a dispensing device 114.

The canister 102 further comprises a pressure inlet 111, constituting a valve (not shown) and a quick connector (not shown) for attaching a gas source (not shown). The canister 102 is initially loaded by closing the pressure valve 110 and attaching a vacuum source (not shown) for removing any traces of air from the canister 102 and subsequently attaching a CO₂ source (not shown) for loading the canister with a specific amount of CO₂. The CO₂ source (not shown) may subsequently be removed and the pressure inlet 111 is automatically closed off when removing the CO₂ and vacuum sources (not shown) for avoiding any leakage. Before the pressure valve 110 is opened, the beverage reservoir 112 is filled with beverage and the pressure lid 113 is sealed onto the beverage reservoir 112. When the pressure valve 110 is opened the beverage reservoir 112 is pressurised and beverage may be dispensed by operating the dispensing device 114. The specific amount of CO₂ loaded in the adsorbing material should be sufficient for substituting the complete beverage reservoir 112.

The applicant has performed extensive experimental research as a proof-of-concept using the above beverage dispensing assembly 100. The beverage dispensing assembly 100 is used due to its reusable features allowing completely reproducible results. For experimental purposes, the canister 102 is further equipped with a pressure gauge 106 for continuously measuring the pressure inside the canister 102 and logging the results using a data recorder in the form of a laptop computer 116.

In one experiment, 434 g of activated carbon obtained from the company “Chemviron carbon” and designated type “SRD 08091 Ref. 2592” is used as adsorbing material and stored inside the canister 102. The cylinder 104 constituting the head space is determined to be 980 ml. The canister 102 and cylinder 104 are loaded with different pressures, such as 5 bar or 1 bar above atmospheric pressure. Beverage is subsequently dispensed in 550 ml doses approximately corresponding to a “pint” which is a typical single serving of the beverage beer. After each dispensed dose of beverage, the pressure decay in the canister 102 is monitored. The main results from the experimental research are presented below:

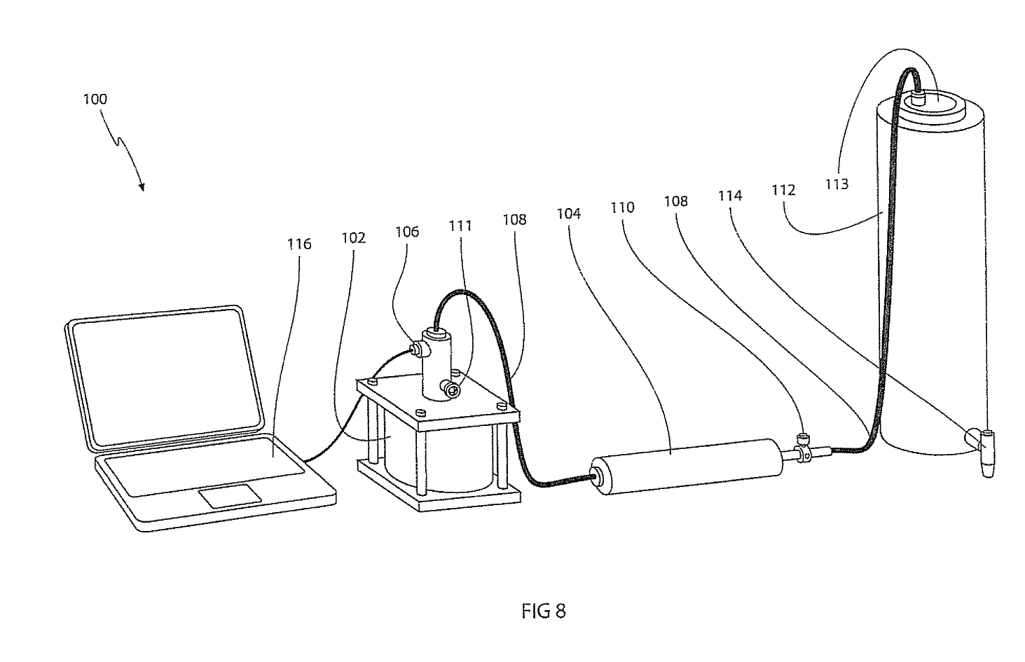

FIG. 9A shows the first results from experimental research described above in connection with FIG. 8. The volumes of the beverage reservoir, the activated carbon and the cylinder are held constant according to above and the initial CO₂ pressure is being varied. The graph shows the pressure decay resulting from the substitution of the beverage reservoir by CO₂ from the canister when the canister including activated carbon and the cylinder constituting the initial head space is initially having a pressure of 5.3 bar. The ordinate axis shows the pressure in the canister in ATO, being the pressure in bar above the atmospheric pressure. The abscissa axis shows the number of 550 ml doses of beverage dispensed from the beverage container. It can be seen from the graph that the pressure is reduced from the initial 5.3 bar to less than 3 bar already after a few dispensing operations. However, most carbonated beverages will not require such high pressures as 5 bar to remain in a consumable condition. It has surprisingly been found out that when reaching lower pressures, the rate of pressure reduction decreases and the activated carbon can maintain the pressure for a greater amount of doses. After substituting about 14 beverage dispensing doses of 550 ml per dose, a pressure of 1 bar remains in the head space from the original 5.2 bar.

However, by substituting another 14 beverage dispensing doses of 550 ml per dose 0.5 bar still remains.

FIG. 9B shows another proof-of-concept experimental research with the activated carbon and the head space initially having a pressure of 1.0 bar. It can be seen that 1.0 bar allows more than 20 beverage dispensing doses of 550 ml per dose, in all more than 11 litres, before reaching the pressure of 0.4 bar, which in the present context is considered to be the lowest driving pressure for allowing a suitable beverage dispensing rate and maintaining a sufficient carbonisation of the beverage. The above experimental research has been performed at 5° C. and 20° C. with substantially identical results, thus it has also been shown that the activated carbon maintains the pressure for variable dispensing temperatures.

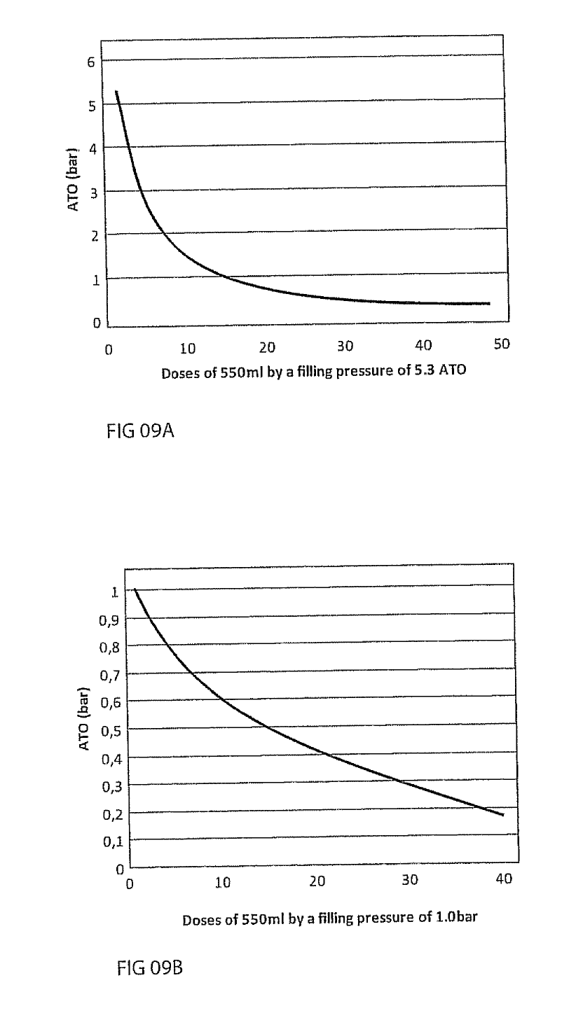

FIG. 10A shows an alternative embodiment of a beverage dispensing assembly 10′″ according to the present invention. The beverage dispensing assembly 10′″ comprises a beverage container 12′. The beverage container 12′ has an opening 32, a beverage space 42 accommodating a carbonated beverage and a head space 44 at the opening 32. The opening 32 is sealed by a closure part 46″. The closure part covers the complete opening 32 and is attached at a screw joint 96. The closure part 46″ further comprises a pair of inwardly oriented piercing elements 98, which will be explained in more details in connection with FIG. 10B. A beverage hose 26′ extends through the closure part 46 into the beverage space 42. The outwardly end of the beverage hose 26′ comprises a tapping valve 20′ for controlling the flow of beverage thorough the beverage hose 26′. The tapping valve 20′ is connected to a tapping handle 28′ for operating the tapping valve 28′. The tapping valve 20′ has a beverage outlet 22 where beverage will leave the tapping valve 20′, provided the tapping handle 28′ is being operated. The beverage is preferably being dispensed into a glass (not shown) or similar.

The interior of the beverage container 12′ further comprises a canister 34″. The canister 34″ is fixed to the beverage hose 26′ and extends between the beverage space 42 and the head space 44. The canister 34″ is separated from the beverage space 42 and the head space 44 by an outer wall 72′. The canister 34′ defines an inner chamber 78′ which is filled with adsorption material, preferably activated carbon. The activated carbon is pre-loaded with the specific volume of CO₂ being sufficient for substituting the complete beverage space 42 while substantially maintaining the pressure in the head space 44. The upper portion of the canister 34′ comprises an initiator 80′. The initiator 80′ comprises a hydrophobic membrane 88 providing gaseous communication but preventing liquid communication between the head space 44 and the inner chamber 78′. The initiator 80′ further comprises a burst membrane 74 located above the hydrophobic membrane 88 and initially preventing fluid communication between the head space 44 and the inner chamber 78′.

FIG. 10B shows the beverage dispensing assembly 10′″ during activation. The beverage dispensing system 10′″ should be activated by rupturing the burst membrane 74 before use of the beverage dispensing system 10′″ for allowing gaseous communication between the head space 44′ and the inner chamber 78′ for permitting continuous beverage dispensing and maintaining the pressure in the head space 44 by release of CO₂ from the activated carbon. The burst membrane 74 is ruptured by rotating the closure part 46″. By rotating the closure part 46″, the screw joint 96 causes the closure part 46″ and the piercing elements 98 to move inwardly towards the burst membrane 74 for allowing the piercing elements 98 to tear the burst membrane 74, thereby activating the beverage dispenser system 10′″.

Beverage may be dispensed by operating the tapping handle 28′, causing the tapping valve 20′ to assume open state and allow beverage to flow from the beverage space 42 via the beverage hose 26′ to the beverage outlet 22′. As beverage is being dispensed, the beverage space 42 decreases in volume while the head space 44 increases in volume and substitutes the beverage space 42. While the head space 44′ increases in volume, the activated carbon in the inner chamber 78′ of the canister 34″ releases CO₂ for substantially maintaining the pressure inside the head space 44.

In an alternative embodiment the initiator 80′ may be omitted and the outer wall 72′ may be flexible allowing the outer wall 72′ to expand during beverage dispensing allowing the beverage space 42′ to be substituted by the inner chamber 78 thereby achieving a dispenser similar to the bag-in-box or bag-in-keg principle preventing direct fluid contact between the pressure medium (CO₂) and the beverage. The drawback of such solutions is the lack of re-adsorption capabilities, which is one of the main advantages using any of the previously preferred embodiments. The screw joint may also be replaced by a press joint or similar activation mechanism.

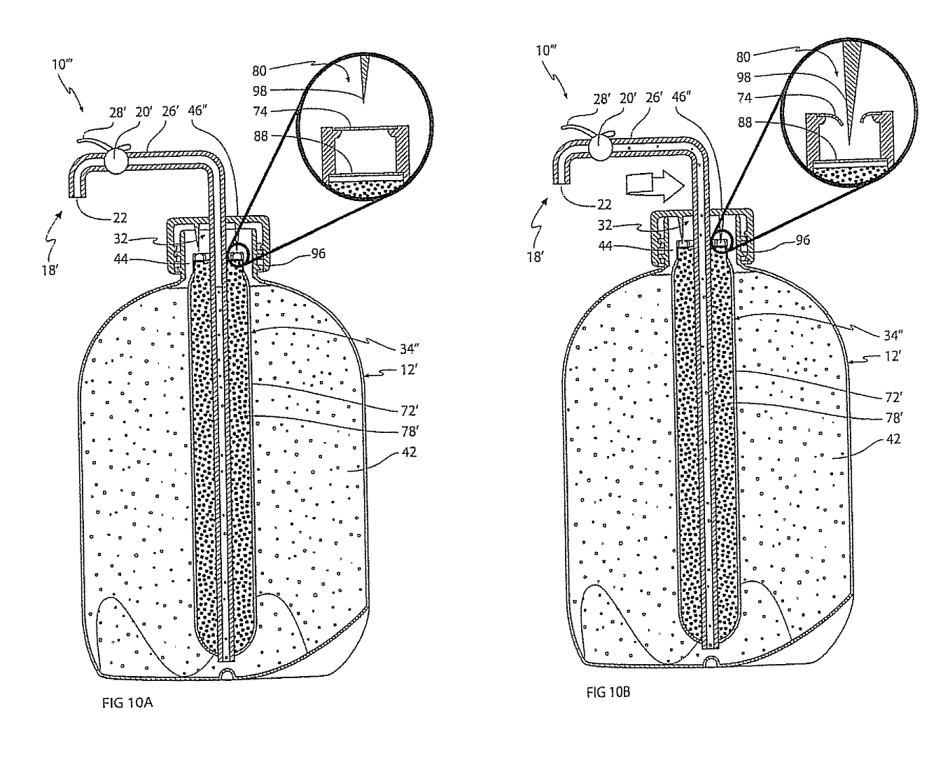

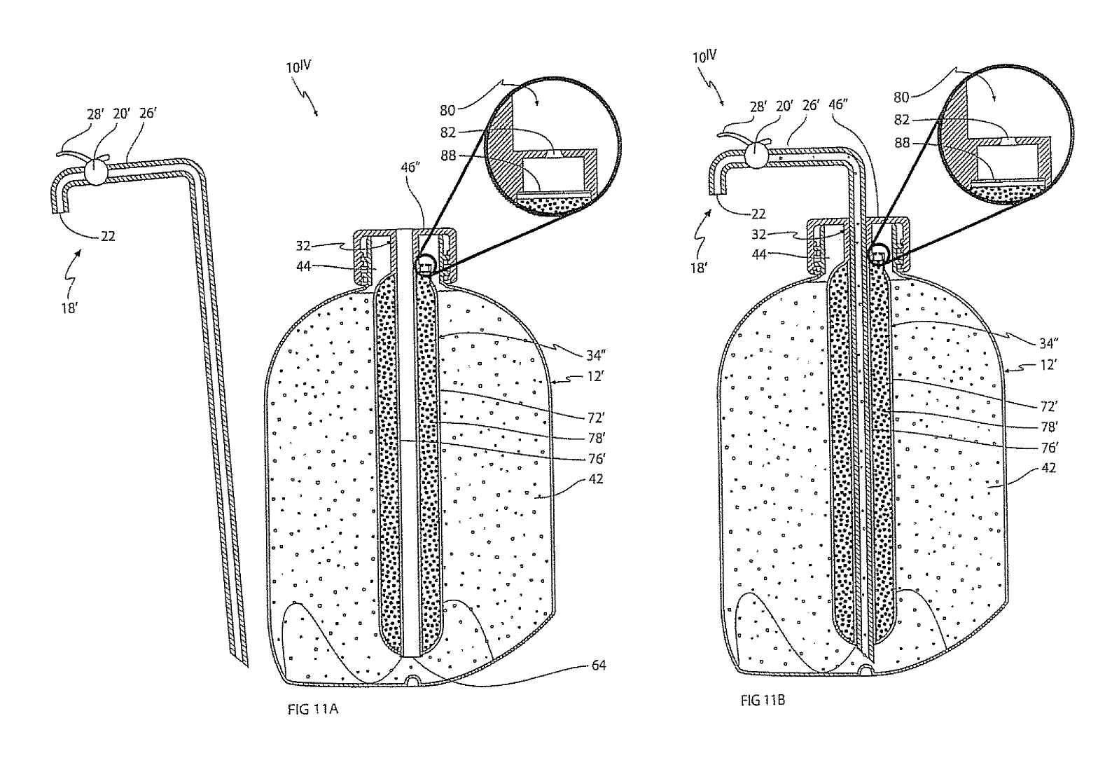

FIG. 11A shows yet an alternative embodiment of a beverage dispensing assembly 10^{IV} according to the present invention. The beverage dispensing assembly 10^{IV} is similar to the beverage dispensing assembly 10′″ of FIGS. 10A and 10B, however, the tapping hose 26′ is provided as a separate accessory which is being installed by the user before the first beverage dispensing operation. The canister 34″ comprises an inner wall 76′ extending from the closure part 46″ to the bottom of the canister 34″ and defining a pass through channel from the closure part 46″ through the complete canister 34″. Access to the beverage space 42 is prevented by a pierceable membrane 64 near the bottom of the beverage space 42. The canister 34 comprises an initiator 80 at the head space 44. The initiator 80 composes the hydrophobic labyrinth 88 and a flow restrictor in the form of a nozzle 82.

FIG. 11B shows the activation of the beverage dispensing assembly 10^{IV} by inserting the beverage hose 26′ into the pass through channel defined by the closure part 46″ and the inner wall 76. The beverage hose 26′ pierces the pierceable membrane 64 and thereby the end of the beverage hose 26′, which should be sharpened for the purpose of easier piercing, enters the beverage space 42. The beverage hose 26 should establish a fluid tight connection to the inner wall 76′. Beverage may then be dispensed by operating the handle 28′ as explained above. It should be noted that in the present embodiment the burst membrane is omitted thereby permanently allowing gaseous communication between the head space 44 and the inner chamber 78, thus requiring the beverage filling process to be performed under CO₂ pressurised atmosphere. The nozzle 82 prevents a too quick compensation of the pressure in the head space 44.

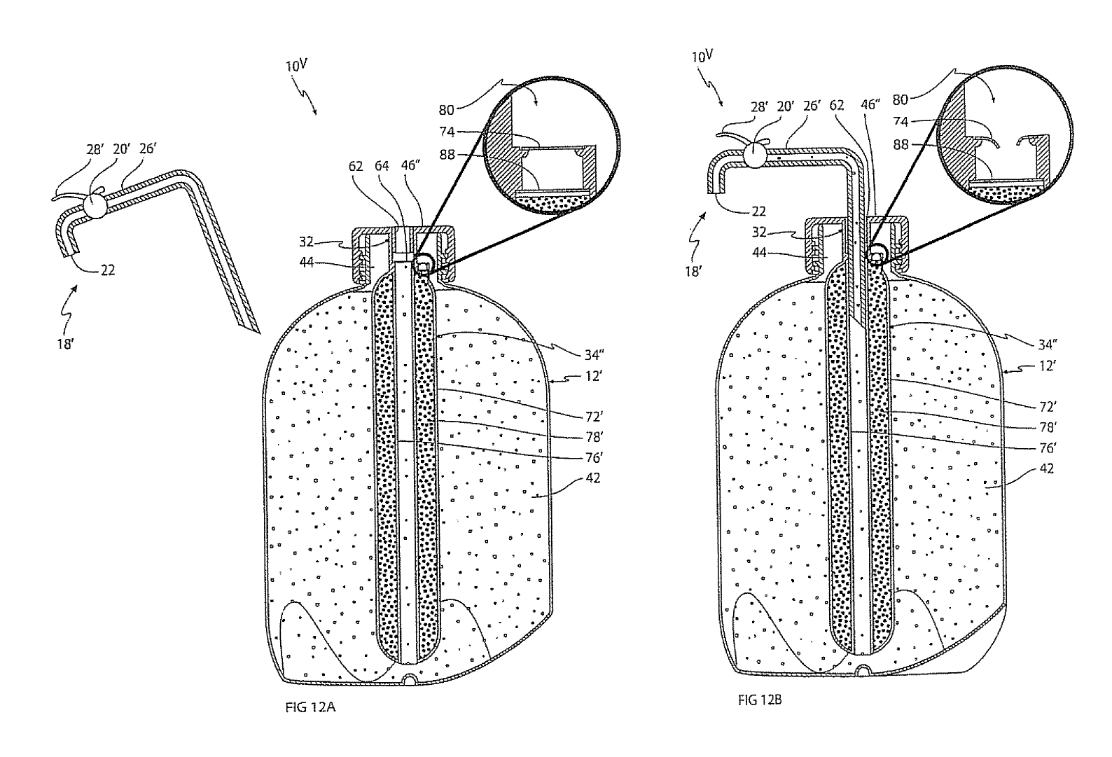

FIG. 12A shows yet an alternative embodiment of a beverage dispensing assembly 10^{V} according to the present invention. The beverage dispensing assembly 10^{V} is similar to the beverage dispensing assembly 10^{IV} of FIG. 11, and likewise, the tapping hose 26′ is provided as a separate accessory which is being installed by the user before the first beverage dispensing operation. The tapping hose may however be shorter than in the previous embodiment since the pierceable membrane 64 is placed in a plug 62 which is accommodated in the closure part 46″. The activator includes a burst membrane 74 which bursts when the pressure in the inner chamber 78 of the canister 34″ exceeds the pressure in the head space 44.

FIG. 12B shows the activation of the beverage dispensing assembly 10^{IV} by inserting the beverage hose 26′ into the plug 62 thereby piercing the pierceable membrane 64 and providing fluid communication with the beverage space 42. When the user initiates beverage dispensing by operating the tapping handle 28′, the pressure in the head space 44 will be reduced and the burst membrane 74 will rupture, providing gaseous communication with the inner volume 78′ for allowing the pressure in the head space 44 to reassume its initial value.

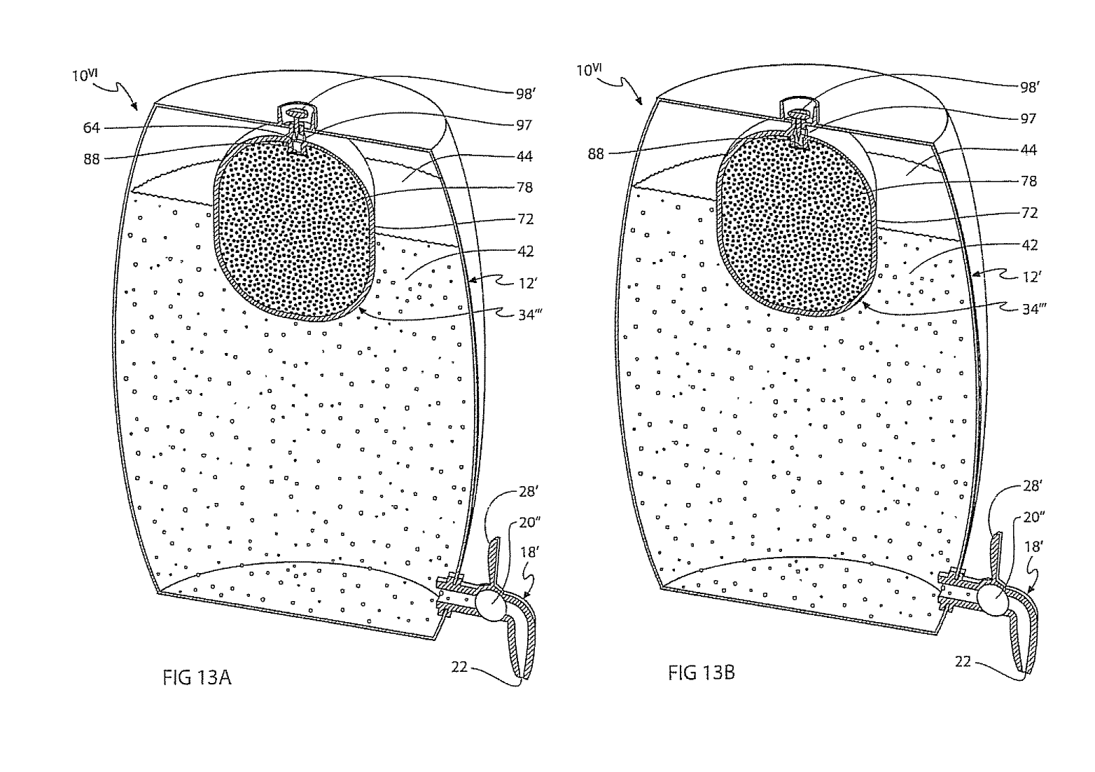

FIG. 13A shows yet an alternative embodiment of a beverage dispensing assembly 10^{VI} according to the present invention. The beverage dispensing assembly 10^{VI} comprises a beverage container 12′ in the shape of a barrel and includes a beverage space 42 and a head space 44. The beverage container 12′ has a dispensing device 18′ which is mounted at the lower portion of the beverage container 12′. The dispensing device 18′ includes a tapping valve 20″ which is operated by a tapping handle 28′. The dispensing device 18′ communicates with the lower portion of the beverage space 42. When the beverage container 12′ is oriented in an upright position, the dispensing device 18′ will be communicating with the beverage space 42 until the beverage space 42 is essentially depleted, and thus no beverage hose is needed. By operating the tapping handle 28, the tapping valve 20″ will open and beverage will dispense through the beverage outlet 22.

The beverage container 12′ further comprises a canister mounted inside the beverage container 12′ at the top and communicating with the head space 44. The canister 34′″ comprises an inner chamber 78 which is filled with activated carbon. The canister 34′″ further comprises a hydrophobic membrane 88 providing gaseous communication between the inner chamber 78 and the head space 44 via an aperture 97. The hydrophobic membrane 88 is initially sealed by a pierecable membrane 64. The beverage container 12′ further comprises a piercing element 98 which may be used to activate the beverage dispenser assembly 10^{VI}.

FIG. 13B shows the beverage dispensing assembly 10^{VI} when activated by pressing the piercing element 98′ inwardly. When the piercing element 98′ is pressed, the pierecable membrane 64 is ruptured and gaseous communication is established between the inner chamber 78 and the head space 44. When beverage is being dispensed and the pressure is reduced in the head space 44, CO₂ is being released from the inner chamber to re-pressurise the head space 44, thus maintaining the pressure. The canister 34 also releases CO₂ to regulate pressure reduction due to temperature reduction and leakage, as well as pressure increase due to temperature increase.

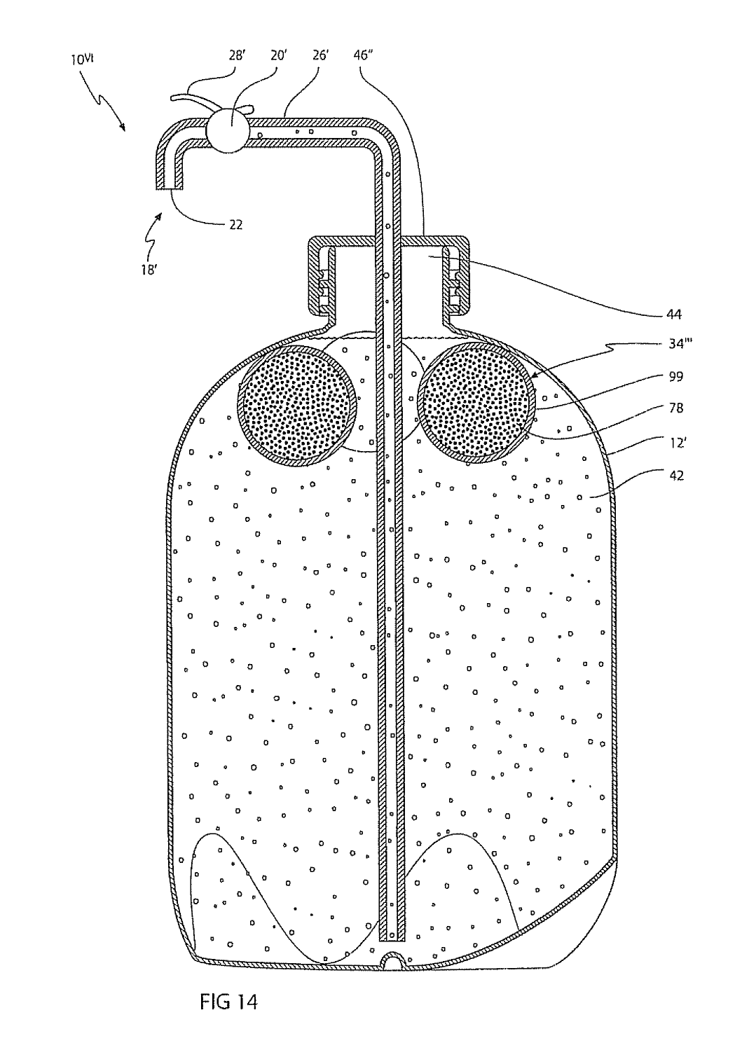

FIG. 14 shows yet an alternative embodiment of a beverage dispensing assembly 10^{VII} according to the present invention. The present beverage container 12′ resembles the beverage container described in connection with FIGS. 10A, 10B; however it includes a canister 34′″ having a hydrophobic wall 99. The purpose of the hydrophobic wall 99 is to eliminate the use of a hydrophobic membrane by making the complete outer wall of the canister hydrophobic but gas permeable. The canister 34′″ should be made having a specific density smaller than the beverage for at least partially floating at the beverage surface. The portion of the hydrophobic wall remaining above the beverage surface will communicate to the head space and the adsorbing material in the inner chamber 78 of the canister 34′″ may release CO₂ to head space 44 as well as adsorb CO₂ from the head space 44. The portion of the hydrophobic wall 99 being submerged below the surface of the beverage will act as a seal and prevent any beverage from entering the inner chamber 78. The benefit of the present embodiment is the very simple design of the canister 34′″, however, the drawback is that the canister typically must be filled in a carbon dioxide atmosphere.

Although the present invention has been described above with reference to specific embodiments of the beverage dispenser assembly, canister, and manufacturing methods, it is of course contemplated that numerous modifications can be deduced by a person having ordinary skill in the art and modifications readily perceivable by a person having ordinary skill in the art is consequently to be construed as part of the present invention as defined in the appending claims. In particular, the canister may be sealed by a water-soluble membrane instead of a burst membrane. Such a soluble membrane may be made of starch, which will dissolve when subjected to beverage, e.g. subsequent to the filling of the beverage container. In some cases a multiple container separating head space and beverage space may be preferred such as a bag-in-box or bag-in-keg and the like.

List of parts with reference to the figures:

```
  10, 10′. Beverage dispenser assembly
  12. Beverage keg
  14. Frame, 14′. Closure part
  16. Grip
  18. Dispensing device
  20. Tapping valve
  22. Beverage outlet
  24, 24′. Beverage glass
  26. Beverage hose
  28, 28′. Tapping handle
  30. Slots
  32. Opening
  34. Canister
  35. Channel
  38. CO₂ flushing pipe
  40. Beverage filling pipe
  42. Beverage
  44. Head space
  46. Closure part
  48. Passage
  50. Rupturable membrane
  52. Pressurisation device
  54. Piston
  56. Pressurisation pipe
  58. Non-return valve
  60. Connector
  61. Access port
  62. Plug
  63. Plug actuator
  64. Pierceable membrane
  66. Feed-through conduit
  68. Pasteurisation device
  70. Tab
  72. Outer wall
  74. Burst membrane
  76. Inner wall
  78. Inner chamber
  80. Initiator
  82. Nozzle
  84. Orifice
  86. Smoothly converging nozzle part
  88. Hydrophobic membrane
  90. Pressure chamber
  92. Canister injector
  94. Weight
  96. Screw joint
  97. Aperture
  98. Piercing element
  99. Hydrophobic wall
100. Reusable beverage dispenser assembly
102. Canister (reusable)
104. Cylinder
106. Pressure gauge
108. Tubing
110. Valve
111. Pressure inlet
112. Beverage reservoir
113. Pressure lid
114. Dispensing device
116. Laptop computer
```

1. A self regulating and constant pressure maintaining beverage dispenser assembly comprising a dispensing device and a beverage container, said beverage container defining an inner space, said inner space constituting:
a beverage space filled with carbonated beverage and communicating with said dispensing device for allowing dispensing of said carbonated beverage; and
a head space communicating with said beverage space and filled with CO₂ having an initial pressure of 0.1-3 bar above the atmospheric pressure when subjected to a specific temperature of 2° C.-50° C.;
said beverage dispenser assembly further comprising at least one carbonisation canister communicating with said head space via a hydrophobic labyrinth and comprising a particular amount of adsorption material having adsorbed a specific amount of CO₂, said particular amount of adsorption material being inherently capable of regulating the pressure in said head space and capable of preserving the carbonisation of said carbonated beverage in said beverage space by releasing CO₂ into said head space via said hydrophobic labyrinth or by adsorbing CO₂ from said head space via said hydrophobic labyrinth, said specific amount of CO₂ being sufficient for allowing said head space to increase in volume and substituting said beverage space when said carbonated beverage having said specific temperature is being dispensed from said container by using said dispensing device and maintaining at least a pressure of 0.1-3 bar above the atmospheric pressure in said head space during the complete substitution of said beverage space by said head space.

2. The beverage dispenser assembly according to claim 1, wherein said head space and said canister have an initial pressure of less than 2 bar above the atmospheric pressure.

3. The beverage dispenser assembly according to claim 1, wherein said head space, after the complete substitution of said beverage space by said head space, has a pressure of at least 0.5 bar above the atmospheric pressure.

4. The beverage dispenser assembly according to claim 1, wherein said beverage space initially occupies at least 70% of said inner space.

5. The beverage dispenser assembly according to claim 1, wherein said beverage space has a volume of 0.5-50 litres.

6. The beverage dispenser assembly according to claim 1, wherein said carbonisation canister allows said adsorption material to adsorb CO₂ when said beverage container is being heated above said specific temperature for avoiding any substantial increase of the pressure in said head space.

7. The beverage dispenser assembly according to claim 1, wherein said carbonisation canister allows said adsorption material to release CO₂ when said beverage container is being chilled below said specific temperature for avoiding any substantial decrease of the pressure in said head space.

8. The beverage dispenser assembly according to claim 1, wherein said hydrophobic labyrinth comprises a gas permeable, liquid impermeable membrane.

9. The beverage dispenser assembly according to claim 1, wherein said beverage container and said dispensing device consist entirely of a material selected from the group consisting of disposable polymeric materials and combustible polymeric materials.

10. The beverage dispenser assembly according to claim 1, wherein said beverage container is made of flexible material.

11. The beverage dispenser assembly according to claim 1, wherein the mass of said particular amount of adsorbing material amounts to approximately 1%-10% of the initial mass of said carbonated beverage in said beverage space.

12. The beverage dispenser assembly according to claim 1, wherein said adsorption material comprises activated carbon.

13. The beverage dispenser assembly according to claim 1, wherein said specific amount of CO₂ initially adsorbed by said adsorbing material is equal to 1-3 times the volume of said carbonated beverage in said beverage space at atmospheric pressure.

14. The beverage dispenser assembly according to claim 1, wherein at least one of said head space and said adsorption material further includes an inert gas being substantially non-reacting to said beverage and said CO₂.

15. A carbonisation canister for use in a beverage container according to claim 1, said beverage container when filled defining a head space and a beverage space for accommodating a carbonated beverage, said carbonisation canister having a specific density of less than 50% of the specific density of said beverage and defining a centre of gravity, said carbonisation canister comprising:
an outer wall,
a first opening,
a second opening being located opposite said first opening,
a channel interconnecting said first and second openings, said channel being substantially straight and including said centre of gravity of said carbonisation canister,
an inner chamber located between said channel and said outer wall, said inner chamber comprising a particular amount of adsorption material having adsorbed a specific amount of CO₂, said particular amount of adsorption material being inherently capable of regulating the pressure in said head space and capable of preserving the carbonisation of said carbonated beverage in said beverage space by releasing CO₂ into said head space, said specific amount of CO₂ being sufficient for allowing said head space to increase in volume and substituting said beverage space when said carbonated beverage having said specific temperature is being dispensed from said container by using said dispensing device and maintaining at least a pressure of 0.1-3 bar above the atmospheric pressure in said head space during the complete substitution of said beverage space by said head space, and
a hydrophobic labyrinth providing gaseous communication between said inner chamber and said head space for said adsorbing material to adsorb CO₂ from said head space or release CO₂ into said head space, said hydrophobic labyrinth having an entrance in said channel approximately at the centre of gravity of said carbonisation canister.

16. A method for producing a self-regulating and constant pressure maintaining beverage dispenser assembly, comprising:
providing a flexible and compressible beverage container having an opening and defining an inner space for filling and accommodating a carbonated beverage, said inner space and said beverage container being variable between a compressed state and an uncompressed state, wherein, when filled with carbonated beverage, said inner space defines a beverage space and a head space;
providing a dispensing device communicating with said beverage space;
providing at least one carbonisation canister comprising a particular amount of adsorption material, said adsorption material being capable of adsorbing a specific amount of CO₂, said specific amount of CO₂ being sufficient for during beverage dispensing at a specific temperature of 2° C.-50° C. and an initial pressure of 0.1-3 bar above the atmospheric pressure allowing said head space to substitute said beverage space while maintaining at least a pressure of 0.1-3 bar above the atmospheric pressure in said head space, said adsorption material being separated from the outside of said canister by a hydrophobic labyrinth, said hydrophobic labyrinth being initially sealed by a burst membrane having a specific burst pressure;
introducing said carbonisation canister into said beverage container;
introducing carbonated beverage through said opening into said inner space thereby establishing said beverage space and said head space, said beverage space communicating with said head space and said head space communicating with said carbonisation canister;
causing said beverage container and said inner space to assume said compressed state and substantially eliminating said head space; and
introducing a pre-determined amount of CO₂ at a specific pressure profile into said inner space while causing said beverage container to assume said uncompressed state for re-establishing said head space having said initial pressure and communicating with said carbonisation canister and said beverage space while said specific pressure profile at least at some instance exceeding said bursting pressure of said burst membrane for causing said burst membrane to rupture and said adsorption material in said canister to adsorb said specific amount of CO₂.

17. A method for producing a self-regulating and constant pressure maintaining beverage dispenser assembly, comprising:
providing a flexible and compressible beverage container having an opening and defining an inner space for filling and accommodating a carbonated beverage, said inner space and said beverage container being variable between a compressed state and an uncompressed state, wherein, when filled with carbonated beverage said inner space defines a beverage space and a head space;
providing a dispensing device communicating with said inner space;
providing at least one carbonisation canister comprising a particular amount of adsorption material, said adsorption material being pre-loaded with a specific amount of CO₂, said specific amount of CO₂ being sufficient for during beverage dispensing at a specific temperature of 2° C.-50° C. and an initial pressure of 0.1-3 bar above the atmospheric pressure allowing said head space to substitute said beverage space while maintaining at least a pressure of 0.1-3 bar above the atmospheric pressure in said head space, said adsorption material being separated from the outside of said canister by a hydrophobic labyrinth, said hydrophobic labyrinth being initially sealed by a burst membrane having a specific burst pressure;
introducing said carbonisation canister into said beverage container;
introducing carbonated beverage through said opening into said inner space thereby establishing said beverage space and said head space, said beverage space communicating with said head space and said head space communicating with said carbonisation canister;
causing said beverage container and said inner space to assume said compressed state and substantially eliminating said head space; and
introducing a pre-determined amount of CO₂ at a specific pressure profile into said inner space while causing said beverage container to assume said uncompressed state for re-establishing said head space having said initial pressure and communicating with said carbonisation canister and said beverage space while said specific pressure profile at least at some instance exceeds said bursting pressure of said burst membrane for causing said burst membrane to rupture.

18. A method for producing a self-regulating and constant pressure maintaining beverage dispenser assembly by providing a pressurised chamber having an initial CO₂ pressure of 0.1-3 bar above the outside ambient pressure, said method comprising the following steps to be performed within said pressurised chamber:
providing a beverage container having an opening and defining an inner space for filling and accommodating a carbonated beverage, wherein, when filled with carbonated beverage, said inner space defines a beverage space and a head space;
providing a dispensing device communicating with said inner space;
providing at least one carbonisation canister comprising a particular amount of adsorption material, said adsorption material being pre-loaded with a specific amount of CO₂, said specific amount of CO₂ being sufficient for during beverage dispensing at a specific temperature of 2° C.-50° C. and said initial pressure of 0.1-3 bar above the atmospheric pressure allowing said head space to substitute said beverage space while maintaining at least a pressure of 0.1-3 bar above the atmospheric pressure in said head space, said adsorption material being separated from the outside of said canister by a hydrophobic labyrinth;
introducing said carbonisation canister into said beverage container through said opening; and
introducing carbonated beverage through said opening into said inner space thereby establishing said beverage space and said head space, said beverage space communicating with said head space and said head space communicating with said carbonisation canister.

19. A method for producing a self-regulating and constant pressure maintaining beverage dispenser assembly, comprising:
providing a flexible and compressible beverage container having an opening and defining an inner space for filling and accommodating a carbonated beverage, said inner space and said beverage container being variable between a compressed state and an uncompressed state, wherein, when filled with carbonated beverage, said inner space defines a beverage space and a head space;
providing a dispensing device communicating with said inner space;
providing at least one carbonisation canister comprising a particular amount of adsorption material, said adsorption material being pre-loaded with a specific amount of CO₂, said specific amount of CO₂ being sufficient for during beverage dispensing at a specific temperature of 2° C.-50° C. and an initial pressure of 0.1-3 bar above the atmospheric pressure allowing said head space to substitute said beverage space while maintaining at least a pressure of 0.1-3 bar above the atmospheric pressure in said head space, said adsorption material being separated from the outside of said canister by a hydrophobic labyrinth, said canister being initially kept in a CO₂ atmosphere at said initial pressure;
introducing carbonated beverage through said opening into said inner space thereby establishing said beverage space and said head space, said beverage space communicating with said head space;
causing said beverage container and said inner space to assume said compressed state and substantially eliminating said head space;
introducing a pre-determined amount of CO₂ at a specific pressure profile into said inner space while causing said beverage container to assume said uncompressed state for re-establishing said head space having said initial pressure and communicating with said beverage space; and
introducing said carbonisation canister into said head space while permanently keeping said carbonisation canister at said CO₂ atmosphere at said initial pressure.
